(19) United States
(12) Patent Application Publication
(10) Pub. No.: US 2010/0194976 A1
(43) Pub. Date: Aug. 5, 2010

(54) COMPUTER BASED AIDS FOR INDEPENDENT LIVING AND HEALTH

(76) Inventors: PETER H. SMITH, ANN ARBOR, MI (US); TIMOTHY R. PRYOR, ONTARIO (CA)

Correspondence Address: STITES & HARBISON PLLC, 1199 NORTH FAIRFAX STREET, SUITE 900, ALEXANDRIA, VA, 22314, US

(21) Appl. No.: 12/719,433

(22) Filed: Mar. 8, 2010

Related U.S. Application Data
(63) Continuation-in-part of application No. 11/439,442, filed on May 24, 2006.
Application No. 11/439,442 is a continuation-in-part of application No. 11/371,224, filed on Mar. 9, 2006, now Pat. No. 7,675,504.
Application No. 11/371,224 is a continuation-in-part of application No. 09/974,250, filed on Oct. 10, 2001, now abandoned.
Application No. 09/974,250 is a continuation-in-part of application No. 10/893,534, filed on Jul. 19, 2004, now Pat. No. 7,401,783.
Application No. 10/893,534 is a continuation-in-part of application No. 10/622,812, filed on Jul. 21, 2003, now Pat. No. 7,042,440.
Application No. 10/622,812 is a continuation-in-part of application No. 09/974,250, filed on Oct. 10, 2001, now abandoned.
(60) Provisional application No. 60/684,959, filed on May 27, 2005.
(60) Provisional application No. 60/660,328, filed on Mar. 11, 2005.
(60) Provisional application No. 60/684,959, filed on May 27, 2005.

(51) Int. Cl. H04N 5/225; G06F 17/30; G06F 15/16

(52) U.S. Cl. 348/373; 707/802; 709/206; 348/E05.024; 707/E17.044

(57) ABSTRACT

The invention herein primarily concerns computer interfaces, particularly those that may be used by those persons who are not familiar and even adverse to computers as they are utilized today. It is particularly concerned with easy to use devices to facilitate the use by senior citizens, widows, and others to use email, computerized banking, and telehealth services. Preferred embodiments utilize TV cameras to sense information pasted to, entered on or pointed to on a page which operation may be done in the home, a vehicle, at work or the like. In a vehicle the invention offers a low cost and convenient method for passengers wearing seat belts to interact with rear sear located displays for entertainment, navigation and telematics.

### CROSS REFERENCE TO RELATED APPLICATIONS

This application is a continuation-in-part of Ser. No. 11/439,442, filed on May 24, 2006; which claims benefit of U.S. provisional application No. 60/684,959, filed May 27, 2005.

This application is additionally a continuation-in-part of Ser. No. 11/371,224, filed on Mar. 9, 2006;

a) which is a continuation in part of Ser. No. 09/974,250, filed on Oct. 10, 2001;
b) which is a continuation in part of U.S. Ser. No. 10/893,534 filed on Jul. 19, 2004;
c) which is a continuation in part of U.S. Ser. No. 10/622,812 filed on Jul. 21, 2003;
d) which claims benefit of U.S. provisional application No. 60/660,328 filed Mar. 11, 2005; and
e) which claims benefit of U.S. provisional application No. 60/684,959, filed May 27, 2005 (mentioned above).

This application is also a continuation-in-part of Ser. No. 09/974,250, filed on Oct. 10, 2001 (mentioned above).

All of the above applications are hereby incorporated by reference.

### FIELD OF THE INVENTION

The invention herein primarily concerns new forms of simple and low cost camera based computer interfaces for use, particularly by senior citizens, handicapped persons and others who are uncomfortable or unable in using computers and computer applications, including Internet applications, in the form they exist today. Preferred embodiments utilize a TV camera and computer to gather information from a page and act on the information, transmitting or storing information in response to the sensed data. In some cases additional information such as the location of a pen or finger on or near the paper is sensed in order to command an action desired. And in still further embodiments, pen (or other writing instrument) or finger position can be actually digitized as well.

We believe the invention is applicable to 5 areas of primary importance to seniors and others: Correspondence with relatives and friends via Email; Telemedicine; Secure Banking, and bill paying; Television Watching, whether on the air or from recorded media; and Information storage, retrieval and reminders. The invention also is an aid to those with physical or visual disabilities.

### BACKGROUND OF THE INVENTION

Today there are segments of the population that are increasingly isolated from modern advances in health care, banking and interpersonal communication, and these segments are arguably the ones in most need, and who want to be independent of relying on others, even when they have children for example that they might call for help. As more of the general population becomes connected to the Internet, those who aren't connected are left behind.

In other areas, the need of an overall system to apply to all persons using it, forces either some to use equipment they are not comfortable with, or perhaps more often prevents a system from being fully effective (since some members cant really use it and backup systems are for example required).

Nowhere is this more important than health and well being (email falls into this), since the population segment in question is generally senior citizens needing to use a computer for the purpose of improving communication with family, health sources, banks and other persons and organizations. An alternative is to use existing methods. Most likely this is the phone, but this is increasingly populated with horribly frustrating automatic systems. Or offshore service bureaus with foreign voices, which can make one uncomfortable, or not understand your needs. Just as VHS tapes are disappearing from BLOCKBUSTER in favor of DVDs, so the old systems will slowly wind down, making it still more difficult for certain sectors of the population.

In addition the phone is error prone and frustrating. We have all had phone instructions confused at one time or another, and “Don't give verbal orders” is an old Army maxim. In addition, in many cases one needs written records (medical bank etc). And secure communication is often a must too. Indeed the solution should be simple and fast and secure. In addition to the foregoing, there is also a need to have a unitary system that can meet at least several of the critical needs in order to justify the cost.

From a hardware point of view are two basic preferred versions of the invention. Version 1 uses a TV camera and computer image processing to look at the users finger or an object held by the user, and the interaction of the finger or object with a piece of paper or other medium.

Version 2 utilizes a TV camera and computer image processing to determine information carried on a page, or on objects attached to the page. In a less desirable and more difficult to use version, a scanner may substitute for the TV camera. However if one uses a scanner or fax to read images of pages, as the camera of the invention does, it becomes difficult if not impossible to read or feed some objects attached to the page, so those devices wont work in many instances. And they are slower and more troublesome, using mechanical motion to scan in one axis.

In operation, version 1 is somewhat like a graphic tablet input to a PC or a mouse, but quite unlike either in many regards. In fact it can act in conjunction with a mouse if desired, or as a standalone computer peripheral. It is basically a software product, since it can be assembled from standard pieces and interfaces available from computer stores today (mounting/positioning hardware not withstanding).

U.S. Pat. No. 5,661,506 (and others such as U.S. patent application Ser. No. 10/631,434 or USPA 2005/0024346) describes a type of imaging pen, which uses writing paper having a prerecorded invisible pattern of pixels. Each pixel contains encoded, optically readable position information that identifies a coordinate position on the writing surface, and may also include a page number and a pad number. The pen includes an imaging system for providing image signals representing images of pixels near the pen tip. A processor responds to the image signals and determines and electronically records positions of the pen tip on the writing surface as markings are made.

This device has been commercialized by ANOTO and/or LOGITECH and perhaps others and has a vague similarity to the invention in the sense that both use a camera and relate to interaction with pages somehow. But that's as far as it goes, as the ANOTO has the camera in the pen, looking at specialized fiducial marks on the page, whereas the invention has the camera positioned to look at the pen itself as well as information on the page.

The ANOTO device and others of similar nature that take their information from the page using a camera in the pen can be used to digitize handwriting. The invention in one embodiment can determine pen movements, but recording handwriting isn't the primary goal of the invention. Rather it is to allow the person using the system to create and send action commands, using much simpler and lower cost equipment than the ANOTO device. There is no special paper required for the invention since suitable sheets can be printed on one's computer printer, should they need to include codes or fiducial marks. And you don't have to use a special pen, but rather one you are used to and comfortable with. The camera used can be employed to take your picture or for other purposes too. In fact, one could argue that the because of the other uses of the camera and computer to which it is attached, the incremental cost of the invention is almost free. The pen can be sterilized easily too, or thrown away, unlike the ANOTO.

A prior art application used for seeing a pen movement in mid air rather than on a page for the purpose of handwriting analysis is disclosed in pending U.S. application Ser. No. 10/182,602, now U.S. Pat. No. 6,947,029. This is not particularly germane to the intent of the instant invention.

Version 2 is a very simplified interface, which has no direct equivalent today. It has been disclosed to a degree in a previously filed provisional application filed in March 2005 and our regular pending case, and is further disclosed herein in several hardware versions for use as a standalone box, or mounted to a door for example. In one version, it can be likened in some to certain fax machines, which could read a form and automatically execute routing instructions contained in various fields on the form. One such prior art document is for example discussed in U.S. Pat. No. 5,060,980 by Johnson, entitled “Form utilizing encoded indications for form field processing”. He discloses the use of a fax machine to read information in one or more fields on a form, and an encoded information such as a bar code relating to a field. Peek, in “Email capable fax machine and methods for using the same”, U.S. Pat. No. 6,614,551, discusses a specialized fax machine to send information to either fax or email addresses.

The invention in version 2 can function by reading fields on a form as well, and sending them to email addresses, which perhaps could be achieved by combining Peek and Johnson. This function is desirable and achieved in the invention using a different hardware and software approach. But the instant invention does way more than this, allowing use for example of pages having no fields (and thus not a form per se at all). And it can do much more than send email.

The disclosed invention in one or more of its embodiments employs a bar code or other design code which is quite unlike conventional barcodes, in that it is visually attractive and decorative, while containing all the data required by the applications envisioned for the invention. A discussion of other such codes and issues is described in U.S. Pat. No. 6,751,352 by Baharav, et al., though the intent there is much more sophisticated codes than our invention requires. Further features and advantages of the present invention will be set forth in, or apparent from, the detailed description of preferred embodiments thereof which follows.

### SUMMARY OF THE INVENTION

The invention herein primarily concerns new forms of simple and low cost camera based computer interfaces for use, particularly by senior citizens, handicapped persons and others who are uncomfortable or unable in using computers and computer applications, including Internet applications, in the form they exist today. As noted, preferred embodiments utilize a TV camera and computer to gather information from a page and act on the information, transmitting or storing information in response to the sensed data. In some cases additional information such as the location of a pen or finger on or near the paper is sensed in order to command an action desired. And in still further embodiments, pen (or other writing instrument) or finger position can be actually digitized as well.

A user of the invention in many cases is not required to know how to operate or even start up a computer in order to use the invention, and methods for providing a high level of security for data transmitted or received are disclosed. The primary application of the device is to 5 areas of primary importance to seniors and others: Correspondence with relatives and friends via email; telemedicine; secure banking, and bill paying; television watching, whether on the air or from recorded media; and Information storage, retrieval and reminders. The invention also is an aid to those with physical or visual disabilities. The primary application of the device is to 5 areas of primary importance to seniors and others.

The invention also is an aid to those with physical or visual disabilities, and we feel can also aid the general population, since the invention makes the use of many simple applications easy and fast. In addition other applications are disclosed, such as selection of music from music files, control of home automation appliances, internet searches and the like.

The invention is much simpler to use than any known prior art that might be considered for transmission of written documents, such as faxes or scanners. The invention also overcomes the mechanical complexity of both, and its simplicity is vital for the target customer group in question, but is useful to all persons when quick simple actions will suffice. In addition our invention builds on time honored and accepted security methods such as Registered Mail to provide the user group a feeling of comfort concerning its use.

For transmission of handwritten messages, the invention is quick and fast. Unlike the ANOTO pen, the message can be written using an ordinary writing instrument on a ordinary piece of paper, cardboard, plastic or anything else that can be seen. The transmitted data can be physician's prescriptions, military maps, letters from grandma or anything readable. And it can be done at low cost. The handwritten information remains in the form it was written too, which means it can be authenticated at the remote site to which is transmitted. And it can be transmitted with a video image of the person transmitting it overlaid at the time of transmission.

The invention is also disclosed in one embodiment for use in a vehicle, in order to work the entertainment system, the navigation system, or to use telematic facilities in the present or future. The invention is particularly useful in this context for use by persons who are not engaged in driving, and particularly thus serves the passengers in the vehicle. In this context there is no known prior art other than classical remote controls used in the home for TV and the like, which in a vehicle can be easily lost or broken. And in any case such remote controls are not easy to work, especially by occasional passengers in the vehicle, or when complex tasks are required. An alternative of having several different remotes for different devices is not practical in a vehicle, which has limited storage space. In addition the invention can be used to easily send emails comprised of handwritten or other information while on the road, and can be used as a simple data storage and retrieval system for items that can be imaged by the camera of the invention. Some of the advantages described above are delivered because we have observed that the logical client for the invention is generally interested only in one page. They do not want to do anything other than put the page in, and have it perform its function, which in many cases is to be transmitted in an appropriate and simple way to the recipient. Such a device and method must be simple to operate. No mechanical motion to jam.

In conventional imaging devices for forms, such as a scanners or faxes, any object attached to the page can either jam or cause the page to stick up away from the platen and be out of focus. The camera of the invention on the other hand has sufficient depth of field (in the z axis) to accurately record the page at the resolution needed even when it is out of position. And the invention can operate with the page out of position in the other two axes (x and y) too, which is typically not done with prior art devices which go to great lengths to mechanically align the document with the device. This makes for much simpler operation and a freedom of maintenance that is essential by use of customers for some of the applications envisioned.

The output of the invention in its basic form is a loudspeaker and printer, the latter typically (but not necessarily) located near the computer utilized, which may be remote from the user input workstation, or incorporated therein. Optionally a display can be provided, such as an LCD flat panel display or a projected display.

The invention can also serve not just senior citizens and others who are unhappy with or unable to deal with the technical complexity of the “computerized” systems of today, but can also serve those who are handicapped. Illustrated for example is a page particularly suited for those having vision difficulties, which either has large writing, large action spots, Braille characters or all three. Caregivers can easily prepare the pages at low cost on a Braille printer to make operation easy and personalized for the individual.

It is a goal of the invention to help those who have trouble with computers as they exist today, to gain all the advantages necessary for their lives, and to enable key applications such as TV watching and music listening, health, email with children and others, and banking/bill paying, and do them easy, fast and well. It is a goal of the invention to provide adequate space on the page for the individual user to write comments germane to the use of the page, or in some cases to attach clippings or photos germane to the page, or in general.

A further goal is to provide a clean interface to a computer that could be used in many dirty, germy environments such that the computer interface equipment such as a keyboard, mouse, or touchscreen does not collect the germs of a patient, or the contamination of nurse attending a wound, or a chef in a kitchen working on a chicken, or anyone doing a dirty or greasy task that needs computer help or documentation support.

It is another goal to allow easy and fast handwriting and picture transmission, especially for those who seldom if ever use a computer.

It is a goal of the invention to provide means for the creation of pages of specific value to the user, to further include the database for the pages downloaded, and the use of the pages once created.

It is a further goal of the invention to provide a secure method for using internet based services by those who are not familiar or able to operate computers.

It is also a goal of the invention to provide a method for persons in vehicles to interact with vehicle controls and telematic sources.

It is a goal as well to illustrate a method for computer entry, which uses markers, or marks, which can be read at a later time by a camera when the field of view of the camera is not obscured.

It is a further goal of the invention to provide TV camera and computer based means to register desired inputs, activate functions of the system such as launching programs and entering or retrieving data.

It is also a goal of the invention to provide a very easy to use apparatus for use in the home.

It is also a goal to provide new methods for meeting banking and health needs.

It is a goal of the invention to provide means for passengers in a vehicle to access navigation, telematic and entertainment and other functions and sources, and execute controls.

It is a further goal of the invention to provide persons in a vehicle an easy way to send handwritten emails and store data.

It is also a goal of the invention to provide new and easy to use methods for sending or receiving emails without typing or dealing with a computer.

It is a goal as well of the invention to provide a device and method of operation, which is intuitive and easy to use by senior citizens and handicapped persons.

### BRIEF DESCRIPTION OF THE DRAWINGS

FIG. 1a is an improved embodiment of the invention disclosed in our co-pending applications for tracking pens and fingers for computer input using colored or other targets on the pen or finger;

FIG. 1b is an embodiment of the invention for use on a door, such as a refrigerator door;

FIG. 2a illustrates a basic workstation of the invention, what we call a “Postbox”;

FIG. 2b illustrates an alternative “Postbox”;

FIG. 3a illustrates an email action page having a color code;

FIG. 3b illustrates a multiple address email action page;

FIG. 3c illustrates a page with a temporary stuck on address;

FIG. 3d illustrates a page in which a address has been identified by machine vision using pattern matching or other suitable algorithms;

FIG. 3e illustrates a page of a telehealth application of the invention;

FIG. 3f illustrates a page of a bill paying application of the invention;

FIG. 3g illustrates a page with an attached name label, which can include multiple names if desired;

FIG. 3h illustrates a page used to aid the person in TV watching activities;

FIG. 3i illustrates a page of the invention used to track weight loss, diet or exercise issues;

FIG. 4a illustrates ballot types of action pages, used with a postbox or other embodiment of the invention to select music from a home music system;

FIG. 4b illustrates an alternative ballot type of action page of the invention;

FIG. 5 illustrates pleasing and useful codes of the invention using a variety of colors, shapes and designs;

FIG. 6a illustrates an embodiment of the invention usable by persons in a vehicle, in this case in the rear seat for telematics and entertainment activities;

FIG. 6b illustrates an embodiment of the invention usable by persons in a vehicle, for map related activity;

FIG. 6c illustrates further detail of the embodiment of the invention usable by persons in a vehicle, for map related activity; and

FIG. 6d illustrates a postbox of the invention between the front seats of a vehicle.

### DESCRIPTION OF THE PREFERRED EMBODIMENTS

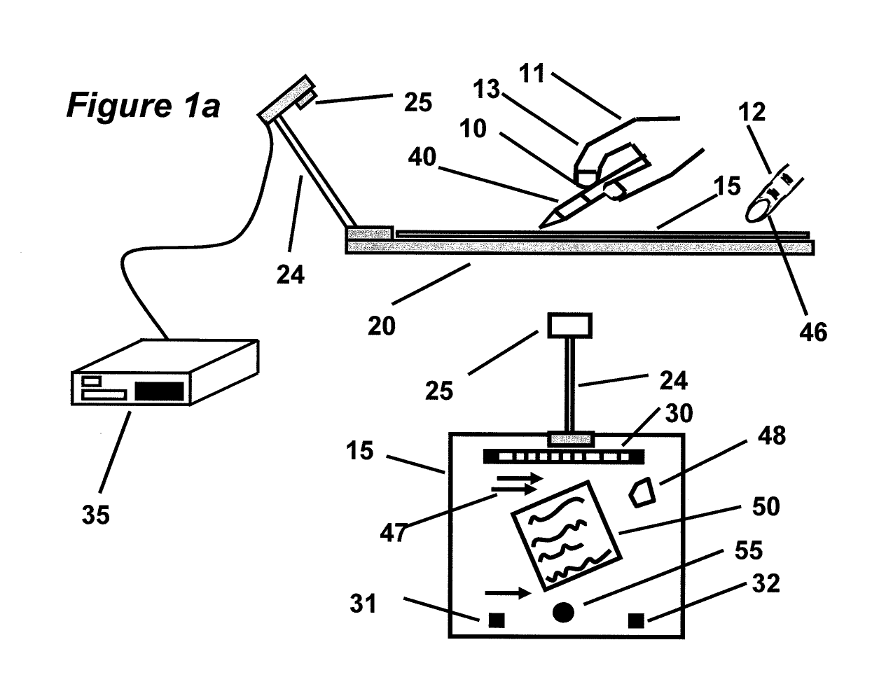

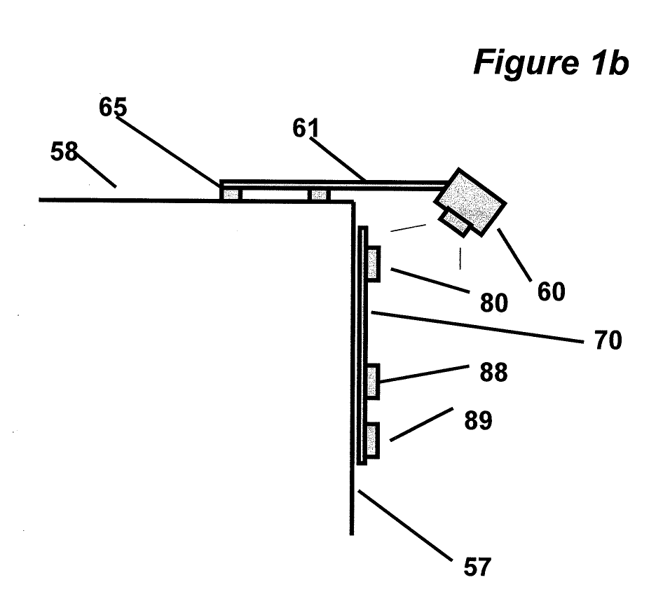

FIG. 1a is an improved embodiment of the invention disclosed in our co-pending applications for tracking pens and fingers for computer input using colored or other targets on the pen or finger. This embodiment in form can replace a mouse or graphic tablet, and in other forms can provide unique functions not obtained with those everyday devices.

As shown pen (or pencil, or other writing instrument) 10, is held in the hand 11 of a user of the device. Additionally, a finger of the user 12 is also shown, which may be used alternatively or in addition to the pen. The user is interacting with a piece of paper 15 located on a clipboard or other surface 20, to which is attached a support member 24 which positions a TV camera 25 to view the paper from an oblique angle theta in this case of 41 degrees. The support member is typically long enough such that the camera is not obtrusive to the user in either its size or presence near the paper. The camera is interfaced (for example by USB2 or Firewire) to and used by the machine vision program in the computer 35 such as a laptop PENTIUM 4 computer used to analyze the camera output.

The camera can be a simple web cam, such as a LOGITECH or CREATIVE brand. The camera is preferably small and light in weight so as to not be obtrusive or cause difficulties with its support, particularly when cantilevered out at an angle such as the 41 degrees mentioned above. Typically the camera field of view encompasses an area at least as large and generally larger than the page, in order that any data on the page or fingers or objects near or on the page can be seen, as well as the points on the page needed to provide code data or to help align the camera system to the page.

The page in this example has on it two sets of information which the camera detects. The first is the color based or other code 30 in this example at the top of the page nearest the camera, while the second is a set of two targets 31 and 32 at the bottom of the page. These targets are used by the machine vision program to correct for miss position of the paper relative to camera and to correct for key stoning of the image due to the angulation of the camera to the page, and the differences in magnification between one end of the page and the other. A hand-held or cell phone camera could also be used in place of camera 25 if desired, with the targets and associated machine vision being used to correct for potential miss positioning of the camera relative to the page (i.e., not directly over the page as would be most desired).

It should be noted that a color code has to our knowledge not been used on a document before for the purposes herein, and may be made pleasing to the eye, such that unlike previous efforts to hide codes, this one is actually used for decoration of a page. It can have different shapes as well and the combination of color and shape, as well as spacing location and other variables creates an unambiguous way to identify persons and addresses.

The color code is used to indicate to the program what page is present and where on the page are what certain items to be acted on by the user are present. The code also carries within it a color reference for the pen tip sleeve 40 which is used by the machine vision program to determine pen location with respect to the page. This pen tip sleeve is essentially a target, which can be a simple plastic sleeve wrapped around the end of an ordinary pen or pencil or other tubular object.

The pen feels good as a result, and feels totally natural in its place moving with respect to the paper.

As an alternative to the pen and colored sleeve 40, one can also track with the camera color on ones finger 12 provided by a colored nail polish 46, or nail polish. A stick on color target can also be used, as can many other types of colored indicators of position. The finger used would generally be ones index finger 13, in this example holding the pen along with the thumb not shown for clarity.

The pen above can be used to write on the page in the normal sense; with a ballpoint tip or whatever is used. But it can also provide an indication of action when it is used in a certain way by the user, called in this case a trigger mode, as it triggers an action. There are normally three trigger modes—a swipe type gesture, comprising a linear motion, where you a slide the pen tip along the page in an indicated direction such as 47 printed or written on the page, and two kinds of hold modes, where you hold the pen on a spot or other design such as picture 48 printed on the page for a timed period or indefinitely until the action occurs.

In the example above, a handwritten note 50 had been written on paper 15, and, after a suitable trigger mode action was executed by the user, a picture of the paper was taken with the camera and a JPEG (or other encoded image of the page and the handwriting on it) transmitted to the email address of the recipient whose name was swiped, for example. The picture region transmitted could purposely be smaller than the page, if desired, or the code and other datum's eliminated from the page image in the computer using standard machine vision programs, before the image was converted to JPEG or other format for example for transmission to a remote computer over ethernet, internet or whatever. Thus a single swipe gesture or other trigger mode action tells the computer to email that page to a person, whose email address may for example be associated with code 30. It is noted that the handwriting can be written right over the trigger mode line spot or design used to trigger the action. This is because it is the pens movement or action which is doing the triggering, not something on the page itself. Alternatively it can be a fingertip, not a pen tip, as noted above which acts to trigger the action.

Alternatively the handwriting can be on a paper that also has addresses represented by hot spots such as 55, discussed in our previous provisional. If the action hot spots are a color on the page, and you write a letter over them, you can filter out the hotspot colors before sending the handwritten or other data portion.

It is noted that if you turn the pen upside down, the camera doesn't see the target 40, and movement or placement of the pen triggers no action. Thus one could in some cases put the ink-dispensing portion of the pen on the opposite end. The distance from the colored sleeve to the tip of the pen can be preprogrammed into the system to allow the program to calculate where the tip is on the paper, allowing for typical pen angulation, and the angle of the camera to the paper.

One does not have to physically touch the paper to swipe or do the other trigger modes. And a lift off mode can also be provided, where you move the pen in a linear motion in the direction normal to the paper.

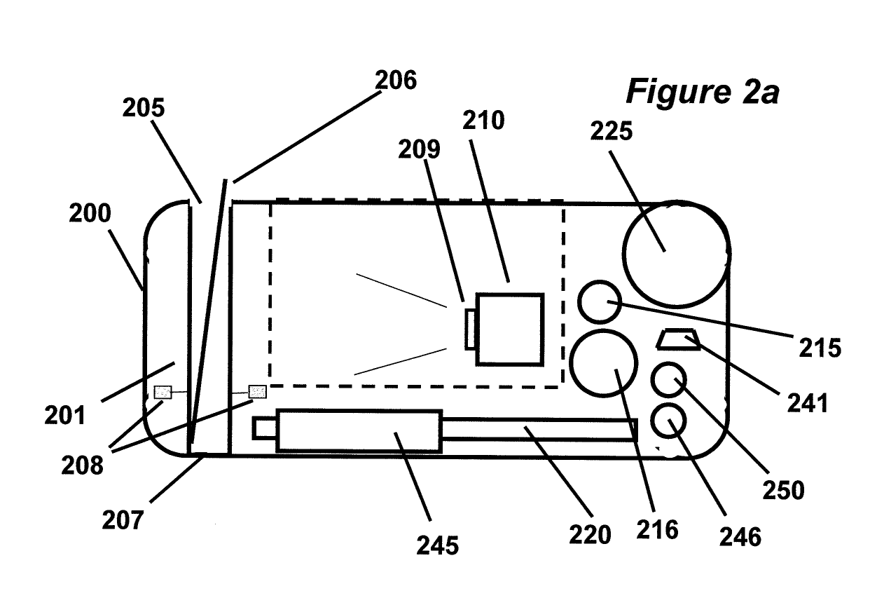

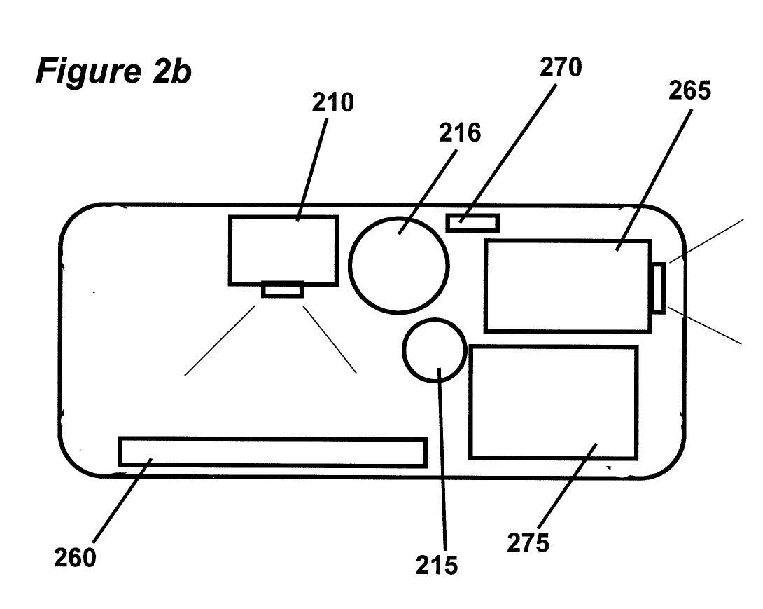

As shown in figure 1b the same arrangement can be used relative to paper on a refrigerator door 57 or other vertical surface. For example camera 60 on support 61 is held at 30 degrees to the door, and secured to the fridge 58 by magnets 65. On the door, one or more magnets such as 80 or other means hold a page 70. And as pointed out in our last provisional, the magnets such as colored magnets 88 and 89 can also be used as an alternative to a pen or finger to convey data from the user. In this case magnet 88 is on an data spot associated with john's email address, and magnet 89 is on a spot indicating that a picture of the page should be sent to the email address indicated by the other magnet 88. For further definition the action magnet 89 could be colored blue, and the address magnet 88 colored green, for example. These simple codes are easy for the computer system to decipher and deal with, and lend a pretty colored appearance to the page or other medium, which is also easy for the user to understand. Even further, a particular color can be programmed to represent the people themselves, such a magnet could be placed anywhere on the page. And even more particularly, it could have a shape, which indicated that it was an email action. This type of thing is discussed in FIG. 2 below.

The computer vision program can track the position of the pen tip to approximately 0.005 inches. And the position measurement in x and y coordinates on the paper is in absolute terms. While this is sufficient to use the pen or finger as a mouse, this later feature is quite different from a mouse, which is incremental. And unlike a mouse, you can actually see the tip of the implement (a pen say) and its position on the page itself. Thus we feel the FIG. 1 embodiment may find use next to computers as a mouse alternative. The pen and paper feel really good, and natural—much more than a mouse or trackball for example.

The physical embodiments shown here in FIG. 1 using oblique cameras attached to clipboards, fridges, desks, or what have you, can be used with most of the data input and page embodiments discussed below.

Considering further the operational steps of one example of application of the embodiment of FIG. 1:

1. The camera takes an image of the page on the clipboard (or desk, etc) and this image is analyzed in the computer.

2. The machine vision software reads the black bars and corrects the image for orientation and perspective.

3. The machine vision software reads the color code and knowing this, the operational program in the computer determines what type of page is present. For the page so determined, the location on the page and the type and function of action functions on the page (swipe locations, hot spots, etc) are determined.

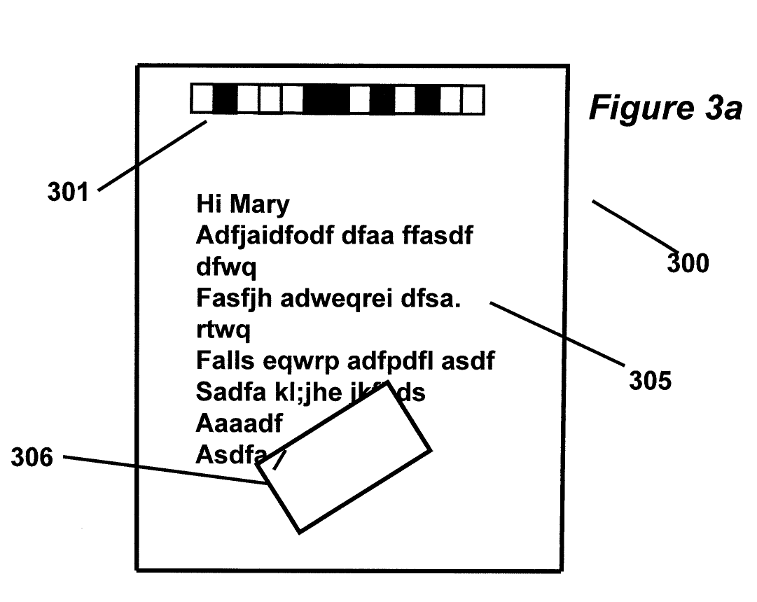

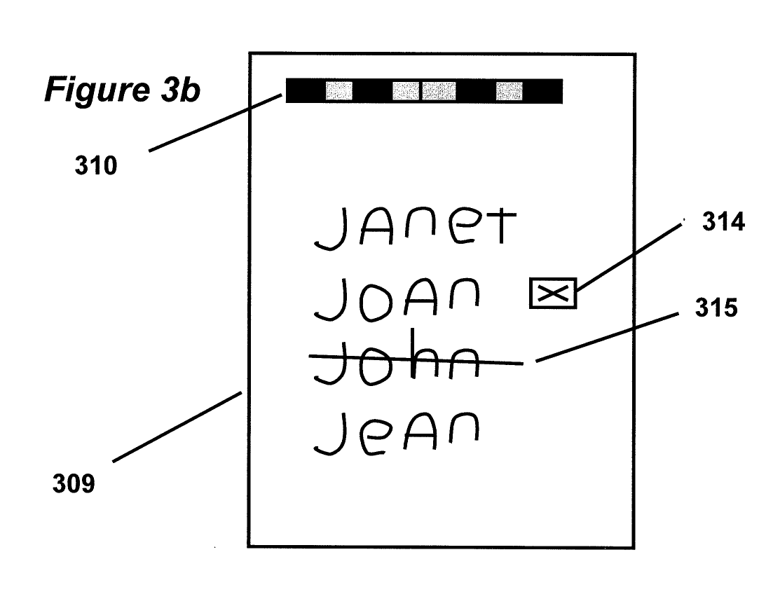

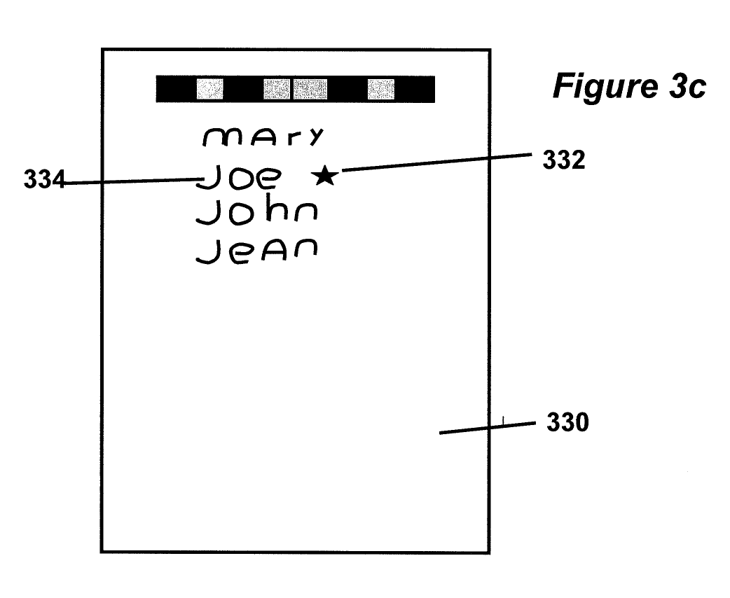

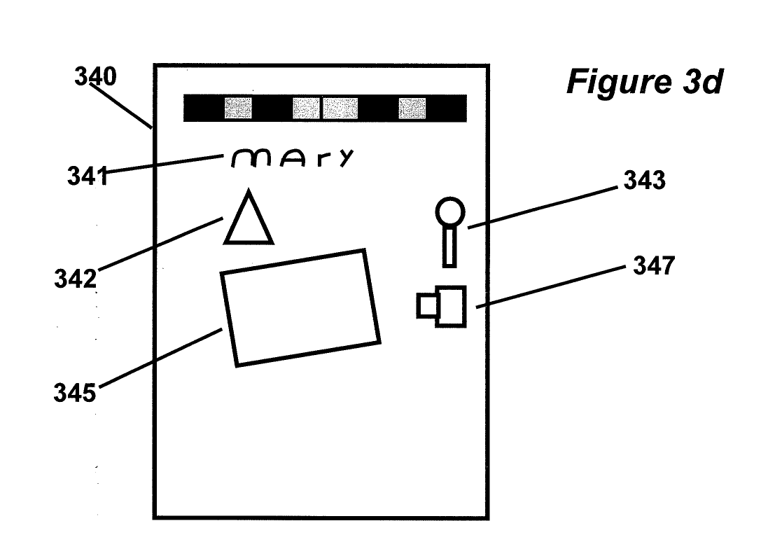

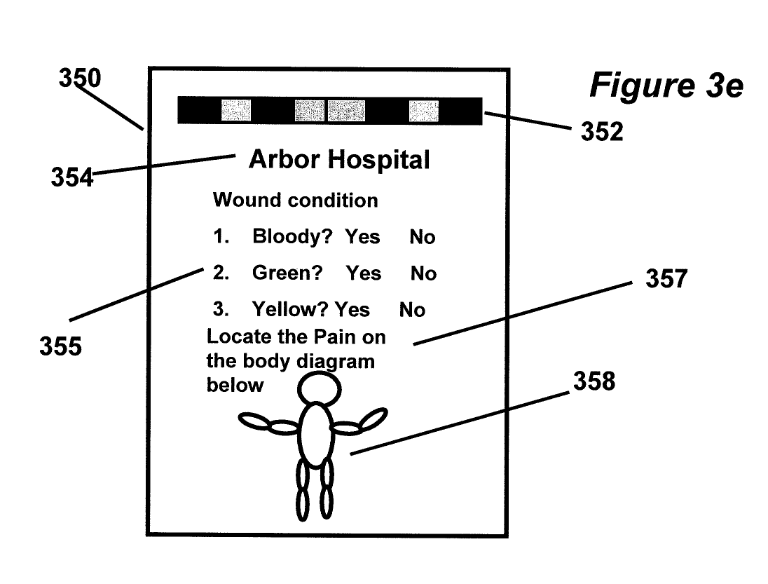

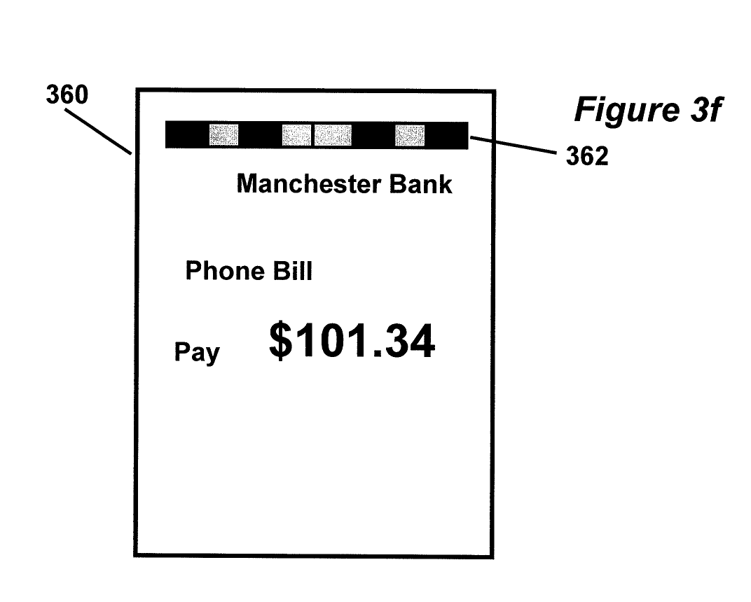

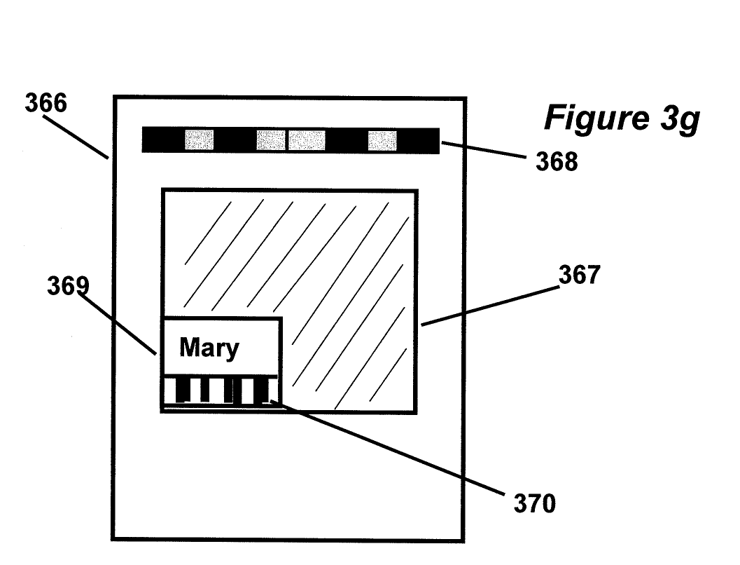

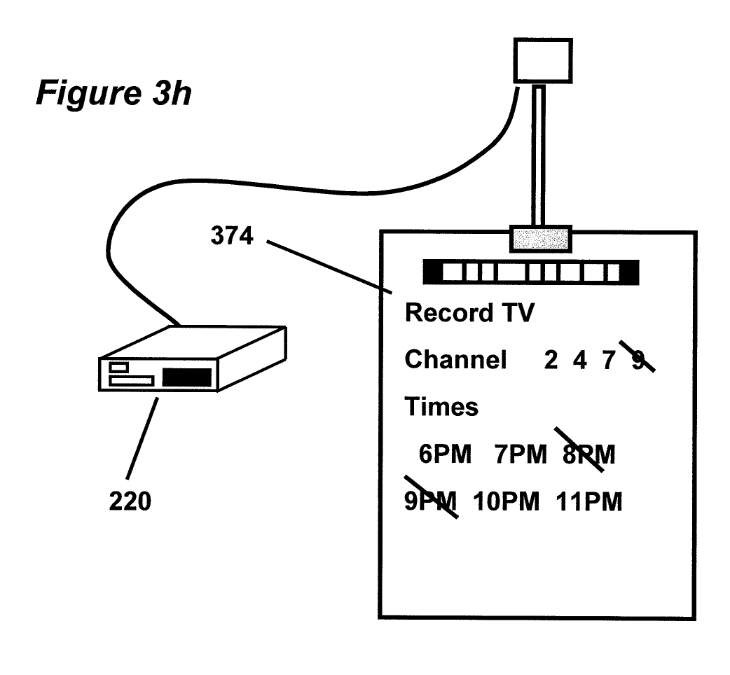

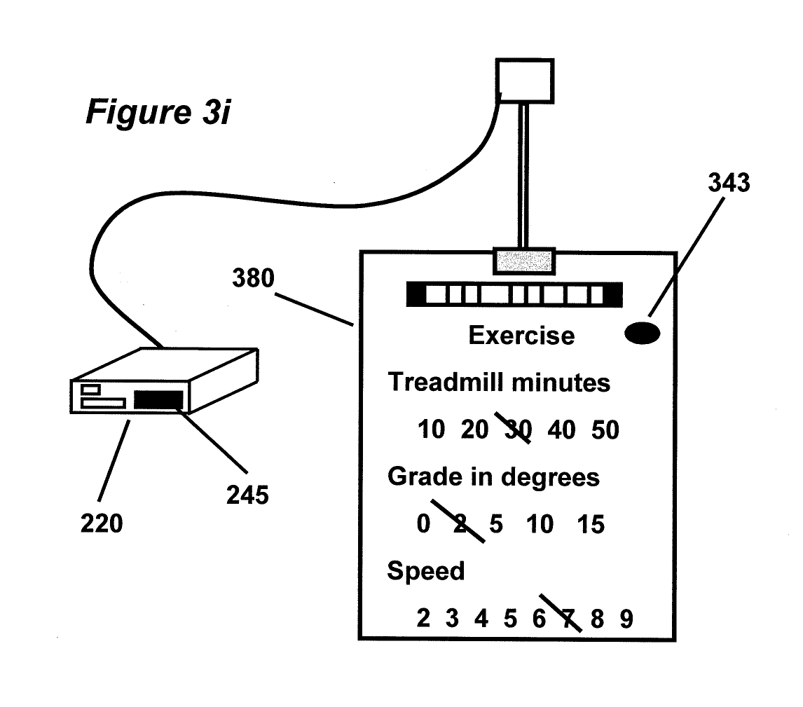

4. The positioning of a pen (or alternatively a finger tip as noted above) or its motion on the page is then determined, and combined with a subsequent action function if any to cause an action to occur. This action can be the sending of an email picture of the page to someone identified by the page code, or action function for example. Or it can be one of many other functions such as those described relative to a somewhat different embodiment of FIGS. 2 and 3 below and in co-pending applications. These can be operation of storage and retrieval systems, home automation systems, banking etc.

Large segments of the population are not comfortable with computers as they exist today, and either do not use them to the level they might, or refuse to use them because of perceived complexity or other factors. This increasingly impedes these persons integration into the mainstream fabric of society. The invention herein discloses computer interfaces and applications of use to such persons, particularly in the areas of most concern to large segments of the population such as health, finance and communication (email and telephony).

To illustrate one example of the problem, as more and more of the children communicate with each other by email, how do they communicate with Grandma, who becomes increasingly isolated from the mainstream? And how does Grandma use the health maintenance and banking/bill paying facilities increasingly available online and of considerable utility (often at the detriment of the old ways)?

Another scenario of the many instances where our invention can help, besides communication with family and friends is the case of a just widowed woman who needs to do her banking and bill paying. She never did this before and does not use a computer. In addition she may have trouble getting to the bank or post office. She would be greatly aided by storage and retrieval capability within her home (perhaps set up by her late husband or her children) as well as an ability to use internet based banking and bill paying solutions.

FIG. 2a illustrates a basic self-contained workstation 200 of the invention, what we call a “postbox”, typically having a housing 201 containing a slot or other suitable opening 205 for input of a paper page 206 which is imaged by camera 210 within the box. The device also typically has a microphone input 215 and loudspeaker output 216, and may have an optional projection display and printer output. Computer module 220, which analyzes the image taken by camera 210 of the page, is typically built into the housing, with a wireless or other connection to a remote printer. Alternatively, the printer 225 can also be built in to the housing as shown. In another alternate configuration, the computer and printer can both be remote, with the camera image transmitted wirelessly to the computer for analysis or further transmission. (Particularly appealing if the camera is located on a moving door such as a fridge door as disclosed above.) Wire can be used rather than wireless in any of the configurations. Typically the whole page is imaged, and over scanned in the maximum field the unit is designed for.

The goal of this device is primarily two. The first is to facilitate the users interaction with remote sites, generally but not necessarily connected over the internet. The second is to facilitate the users use of a computer with the home or other place. At this writing this is seen primarily for the purpose of storing and retrieval of data, or the control of household devices such as TVs and music sources and media.

It is noted that the functions here can also be done with the FIG. 1 device or others disclosed herein or in co-pending applications, but in the particular case of the postbox, the interaction is solely between the camera and the page or items on the page, not with the users finger or some implement such as a pen held by the user. The goal of the postbox is even more specialized in that it is primarily a single page entry device. While it need not be limited to that, it is fastest and easiest to use when just a single page is to be entered. And fast, easy, and robust operation is the primarily goal, such that persons with little or no computer skills can use it, or persons in a hurry, or in some cases persons with certain disabilities. Fast and easy are appealing aspects even for those with normal computer training.

Let us now consider a basic application of the device, namely to send a handwritten letter to friend who has an email address. This is very appealing to those who either can't type, or don't wish to type, or have an opportunity away from a computer to write a note by hand and wish to subsequently send it with the least fuss.

In one basic form, the user pulls a page 206 from a file drawer in their home say. This page was for example filed under the name MARY, and has a code at the top used to tell the computer that this is a page to go to Mary whose email address has been stored in the computer. Alternatively, the email address can be encoded on the page itself. The word MARY is also desirably printed or otherwise written on the page. It may even be written by the user, along with some hand written notes concerning Mary or some other subject.

The user writes the note, for example a birthday greeting, on the page, and when through, drops the page in slot 205. As the page reaches bottom it trips a photo switch 208, which causes the camera 210 to take a picture of the page, including the code and the handwritten information. Since the taking of the picture is virtually instantaneous, the user may in fact never let go, and just insert and withdraw it in one motion upon hearing the computer 220 generate a “beep” from the loudspeaker 216. The photo switch may optionally be used to fire an auxiliary light source such as white light LED 209 which can provide a stroboscopic illumination if desired helping to capture the image without blur. Such high speed capture, using a short duration camera exposure or strobe lighting of the document allows a through-feed type of postbox to be built where the page may be dropped in by a user at the top and simply passes through the device for image capture and then falls out the bottom, for example, as shown through optional bottom opening 207. This is useful where a numerous sheets needs to be inputted for some reason, especially if the sheets once inputted are no longer needed and can fall into a trash can or shredder.

The slot 205 is desirably large in width such that the paper (or other page material such as plastic cardboard or the like) slides in easily, and can desirably provided with radiused lead in curves at the entrance to the slot, such that persons with shaking hands, or blurry vision can easily navigate the paper into the slot. The ability to take different materials is an advantage since common items like recipe cards, and such can be used easily. And sticky plastic or metallic pages can be used as well, both of which are difficult or impossible to use with scanners and faxes.

When the picture of the page is taken, the loudspeaker if desired sounds a beep, and the person removes the page. The data on the page as discussed in FIG. 1 above is converted to a JPEG file and transmitted to Mary's email address over the internet. This can occur in one mode, by actually accessing the Internet only as a result of getting the instruction to send email, not staying connected all the time, which has security issues, associated with it. When the message is successfully transmitted, another sound can optionally be provided the user if desired, and in a preferred mode, the device disconnects from the internet.

In another mode of operation, the page can be put in the slot, and if the user has indicated they wish to send a voice message, the unit can record voice for let us say 30 seconds after the beep is sounded. And then that voice record is transmitted as a file to Mary. The indication of an action such as record voice can be done in several ways, some of which have been discussed in our co pending applications. This then results in something like a voice mail on a phone, but doesn't tie up one's phone, and it can be sent to 10 people at once via email. To work easily, the invention in this form can, like the example of FIG. 1, utilize a page having a code, for example a color bar code, which has been pre set up relative to addresses or functions on the page inserted, which indicate an action to be taken by postbox computer. For example, the person can get a Mary page from a file, write on it, and drop it in the post box. The color bar code is read and the system knows to take a picture of the page and email it to Mary, since beforehand the program has been programmed to associate that code with this task.

It should be noted that the page can be of plastic, with a sticky surface on it to which the user can in turn stick their letter, photo, recipe card or whatever to it for transmission. When sent, the user takes off these items (if desired) and files the page back in the Mary page file.

In another version, the page can be an email page, with a code at the top indicating such and the same thing in writing as well. In this case there are 8 boxes on the page, one for each of the children of the person in this example. The person colors in the boxes of those who are to get the email, and drops it in the box. The machine vision program called up by reading of the code, analyzes the page and determines which boxes are colored in. Those persons get the email, and a voice playback can confirm this to the user, before the transmission is made if desired.

In another version, the user can cross out the names of those who are to receive or not to receive the email. Or the user can put little stickers, which can be identified by their color next to, or over the names of the recipients. Any or all of these possibilities can be achieved with modern machine vision programs such as sold by MATROX, CORECO, COGNEX and others. The MATROX MIL version 7 imaging library running on a PC is an example. In all of the above cases except the simplest use of a dedicated page for one function (such as sending a picture of the page by email to Mary), the code at the top or elsewhere on the page has told the system what program to use in analyzing the page, and how to associate the data obtained with the task. The colors of the code, and even the placement of the code on the page can also carry meaning.

Alternatively, there are several other possibilities, which do not use a code at all. For example, lets take the case of sending the picture of the page to Mary. We can just take a plain piece of paper and attach something to it that means to send the picture to Mary. In the simplest case this could be a plastic piece in the form of Mary's name, which is clipped to the page. After use its put back in its original place and used next time. The machine vision program can recognize this by its shape or color or signature, particularly since it can be taught to the program and template matched at a later time this can be true no matter where on the page it is, and with some orientation invariant programs such as Patmax by Cognex, it could be in any orientation. Thus the user typically puts it where other information is not present (such as handwriting or a photograph taped to the page, etc.).

Another attached item could be a post-it type note stuck on temporarily to the page. This would be recognized by its color, or shape, or other characteristic. It can have writing on it saying what it represents. The color, writing or other identifying characteristic can be created by the person themselves and taught to the system. The machine vision program can use more than one method fro identifying, for example shape plus color.

The name Mary could also be stamped on with a inkpad type stamp made up for the purpose. Or a paper cut out word Mary could be stapled or glued on for example, the latter somewhat akin to licking a stamp today—appropriate for something named a postbox.

As will be appreciated more complex image processing may also be used to actually read the characters in the word and decipher it that way. But this invention is made for simple tasks, where a limited set of persons or organizations are typically dealt with in a repetitive manner. We do not feel OCR and other such complexity serves this application well. The page may be metallic rather than paper or plastic based. If so, the items attached may be magnetically attracted.

The shape of the items, like the Mary name, can mean something. Musical notes, dollar signs, dollar amounts, and the like are all things that could be taken from a storage location and used for different purposes, as long as their meaning had been pre programmed, or could be identified by a generic program. For example, one could create a generic program that looks for a blue dollar sign anywhere on a page, and if it finds it, it reads the number after it as a value to be inputted in some manner to a transmission or other activity of the postbox. If a red dollar sign was used, the number is to be subtracted, say.

The simplest post-box has a clean exterior appearance and no display, and rather uses the printer for output, since in limited quantities the paper cost is not prohibitive, and reading paper records is more convenient and “natural” for many people than staring at a computer screen as has become the norm today for many. And when getting out put such as from the internet, this also allows that no data be stored in the computer itself, but rather is just printed and stored on paper. Or it goes to a separate output computer.

The post-box can be used with appropriate connection of the computer 220 to outside servers such as through DSL modem 241 and the like to interact via email with the outside world so to speak. Typically this is email with trusted family and acquaintances, banking and bill paying, and telehealth.

But the invention also can be used internally within the home or other locale to aid the user in other tasks of interest, such as watching TV (live or from media) and in filing and retrieval of information such as pictures written records and the like. And it can be used to interact with music records as well. Some of these functions can even operate on hardware optionally within the post box itself.

For example consider large hard drive 245 which when operated with computer 220 can be used to store TV shows obtained over a cable network via connection 246. These shows can be replayed using display output 250 to a TV display not shown. This display could be on the postbox too, doubling also as an information display from email or the like if such was desired. In this form, the postbox is like other TV recording devices, except that the instructions for doing so are given by simply configuring and inserting a page, as will be shown in FIG. 3 below.

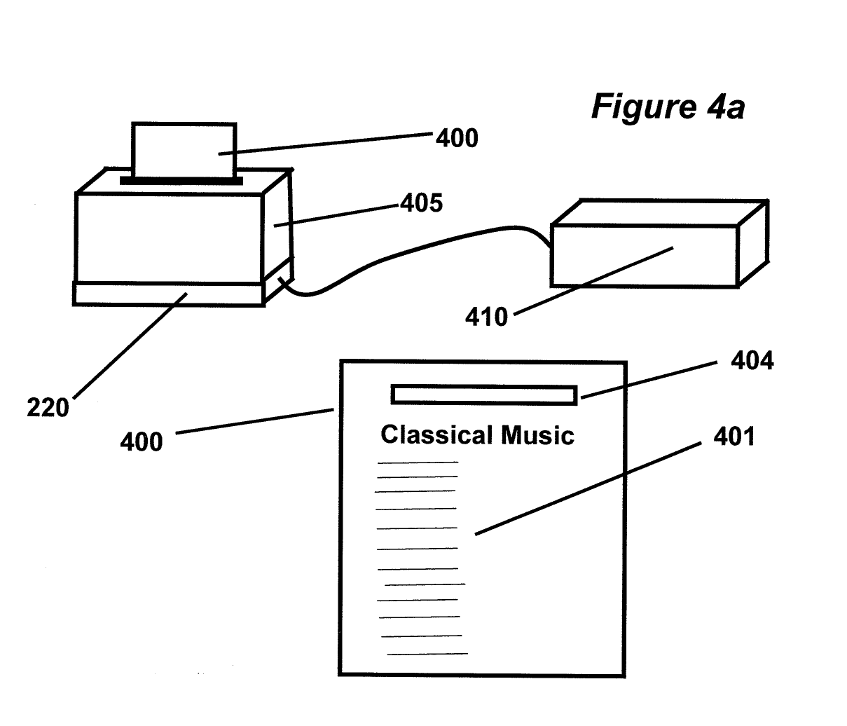

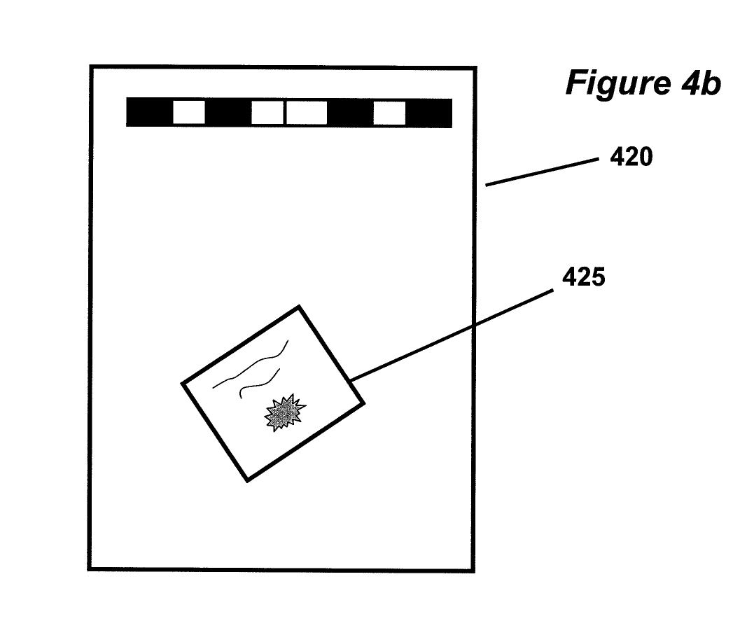

Similarly the computer and hard drive may be a music storehouse for the user, or the postbox may be used to access and control the playing of tunes from external computer storage. An application of this type is discussed in FIG. 4.

The goal again is to help those who have trouble with computers as they exist today, to gain all the advantages necessary for their lives. And to aid groups of persons, in which one or more members of the group may have trouble with computers, and thus hold back group progress unless all can use the features available.

FIG. 2b illustrates an alternative postbox version with horizontal slot 260 to slide the page into and a projection display 265 shooting the image projected (e.g. an email, or an internet data or a TV image used simply for viewing) onto a wall near the postbox itself. When not in use, there is nothing to see. The camera 210, speaker 216, microphone 215, and other computing equipment 275 are also shown. A wireless port 270 atop a remote printer can keep the overall package small. And the furniture look is maintained. Such a postbox, or for that matter all postboxes of the type herein described, can be fitted with an optional display and keyboard, assuming the computer program can accept them, but the general intention of the invention is to make it usable for those who don't feel comfortable with such peripherals.

While discussed above in the context of home applications, the postbox can be used in other places as well. For example, in the car, to send quick emails or other functions by dropping hastily scribbled notes into the machine (realizing it is hard to type in a moving car, and voice is sometimes drowned out). More on the car application is mentioned below.

To recap the above to some degree, the FIG. 2 device in one advantageous example operates as follows.

The simplest version is when you write on a blank page the name of the person or organization to whom something is being sent, for example to your daughter Mary. (This sort of address label can also be to your own file, such as the word TAX.)

You write this name by hand, or alternatively attach a pre made name or other symbol for Mary to the page. Typically but not necessarily you might choose to write it at the top of the page, to make it easier for the software to find it. It might also be noticeably dark and large and possibly of a special color, all of which aid the finding of the address label.

You then attach to the page, or write on the page, or both, information such as a handwritten note, photo or whatever.

You drop the page in the slot of the postbox, and when the edge first placed in the slot breaks the photo switch (or another means is used to tell the camera to read), the camera 210 takes the picture of the page which is transferred to computer memory 220. When this is done, the computer generates a “beep” or other suitable indication and the user may take it out. Usually this is all in one motion, as the camera is near instantaneous in its ability to take the picture assuming suitable light power in its LED or other light source has been provided (or sufficient light is in the room, if the FIG. 1 example is used).

The machine vision software then searches the page for a match to one of the address labels stored in memory, which has been taught or otherwise entered during a set up phase. Typically for an average person there is a limited number of possibilities that aids this task greatly.

When the match is found, the action is taken, such as sending the image of the page as a JPEG or other file to Mary's email address. If desired, the computer can give a voice annunciation on the loudspeaker saying it found “Mary” and the user can use the microphone to confirm that if desired. Or alternatively, if nothing is heard back, the machine just sends it. Many other methods can be done as well to give the user the degree of feedback and control desired. For example a “Send ” button could be on the outside of the postbox, to avoid the voice input just mentioned.

FIG. 3 illustrates action pages for some typical applications of the invention used in the apparatus of FIGS. 1 and 2 above and other embodiments, for example for email, banking, and telehealth applications, weight loss, and TV watching.

FIG. 3a illustrates an email action page 300 having a color code 301 at the top telling the computer of the invention (such as 220 in the postbox above) to send the page as an email to Mary's email address. The user writes a message 305 on the page, and/or attaches something to it such as picture 306, and sends it using the invention—postbox, on a fridge on a clipboard or wherever. FIG. 3b illustrates a page 309 whose code 310 says it is meant for emailing to all the names on the page that have been identified by altering the page in some way. Identification can be by checking a tick box, such as 314, crossing out a name such as 315, or other means, and if desired a combination of means, since any change to the name or region around it can mean that it was either selected or not selected, as the program requires. Note that the significance of a name can be taught to the system. For example, the name Janet can be printed on the page, and the computer taught that when the signature Janet appears it means her pre-stored email address is the one. The system does not have to read OCR to do this. But rather on a page of relatively few names, identify either the presence of Janet, or the lack of Janet (i.e., crossed off). Because there are a limited number of names, the written (printed or handwritten) pattern of the full word Janet can be compared to stored patterns to determine that it is Janet who is desired.

FIG. 3c illustrates a similar but different situation to FIG. 3b in which items are stuck on temporarily onto a page 330 to provide the address function. In this case a reusable page can be used, which can be nicely laminated for example to stand up for years. For example, on the page would be all of ones children's names, and perhaps grandchildren too (only 4 are shown for clarity). You just stick a colored star 332, for example, on the name such as name 334 of the one you are sending the email too, or next to it. The star can be identified by color or shape, or the name can be identified by the fact that it blocked the name even (if so programmed). When you are done sending, you remove the star. The computer vision system can be programmed to identify the page (from the limited set of pages used by the person) and recognizing it is the list of children's names for email, associate the colored star with the name previously programmed, and thus send the email of the page to them. If the star is an ALL, then all children get the message.

FIG. 3d illustrates another email example in which any sort of page 340 can be used (not just one with a code at the top say). In this case the computer vision software of the computer simply looks for the name of somebody in the family, Mary, Janet, etc. When the match is made, for example using COGNEX “PATMAX” pattern matching software, the computer then knows that page is to go to the person(s) identified. The matching criteria can be anything that works reliably. The pattern of the written name itself can be used, and a piece of plastic or paper 341 can be attached in the shape of the name, MARY for example. Alternatively a special color or shape connected with the person can be used such as the triangle 342 which might represent “Marge”. The name item can if desired be placed in a consistent location, say at the top, but it can alternatively be anywhere on the page if desired. It might be clipped on, stuck on, or in anyway attached that is practical for the user in question. To this end, one can consider using a piece of sticky plastic or other material as the page. In this case you just stick (generally temporarily) the name piece to the plastic. And you can stick a postcard, photo recipe or something else too, including a note 345 written on a piece of paper.

It is also possible to add further instruction labels such as record voice label 343 shown to the page. When the machine vision program identifies this due to a match with pre-stored data or pre-taught information, in addition to identification of the recipient Mary, it is programmed for example to tell the user to record 20 seconds of recording into the mike of the post box. Just as before, this label does not have to be in any particular location on the page. Alternatively one can use a page which has a place on it to be checked off, or colored in or whatever, to signify that a voice record is to be taken and attached to the email in question.

One might also choose to add a third label such as a picture icon label 347, which would tell an optional TV camera to take a picture of the user, and send it too with the email, or perhaps to paste it to the page being sent in a region not used for handwriting or other information, or to paste it as a watermark on the page. The preparation of the transmitted page is made in the computer 220 before the message is sent and all this activity is desirably automatic and transparent to the user, who just can take the paper and walk away if desired.

The desired label shapes and colors can be balloons or designs of any type and one can teach the design and color and shape any or all to the camera and computer software based machine vision system.

FIG. 3e illustrates a telehealth application in which a coded page 350 is addressed by the code 352 at the top to a medical organization or person, also indicated in written text 354. The page is pre-made with questions 355 to be answered for example, and has an area 357 to describe for example the pain, by drawing a picture 358 for example on the page. This could be specially prepared for the particular patient with likely problem areas for ailment in question. The code for the patient would be identified on the page, to signify whom it was sending the information. The thing about our postbox for the elderly is that it is ultra easy and uses handwritten notes. And it is perhaps less of a hassle than calling someone. (Which is nearly impossible in some cases, for example if you are trying to reach your family doctor easily in anything short of an emergency.) The postbox can also take and transmit a picture of the person using an optional camera, useful if there is something on the patients exterior that is of interest.

The person in one mode of operating can have a group of pre made sheets with known problem areas. This service wouldn't replace a random problem (though that too could be written down). In the known area, all the questions needed generally would be on the page, and you just send it in with your quick answers. Then it could be machine read at the other end, and action taken. We didn't really include yet the idea of machine reading an answer coming in.

FIG. 3f illustrates a page 360 used with a bank to pay bills, a feature of the invention helpful to a frazzled single mom or a widow for example. The bill-paying task is one that really is difficult for someone not into numbers and such—probably also the same person who doesn't like computers. Nobody likes the bill paying chore in any case, so it's possible the invention's ease of use would help everyone including those fully capable of using existing computer based bill paying services.

Lets assume a helper/caregiver has set up the whole thing for you (the bank could sponsor this!). You go to your file that has telephone bills. In the file, besides the bill, is a page of the invention, which has coded, in code 362, the bank address and phone company bill account. You take the page and drop it in the postbox or otherwise show it to the camera in other embodiments. The program first finds out your balance in the account (for the moment let's say you have just one account), and tells you via a voice playback on the loudspeaker, or prints it or displays it or all three. It then needs to determine how much of the bill you want to pay. That you could enter by coloring in things on your page, or adding a label having an amount on it to the page. Or you voice it in (number recognition is pretty well perfected). This is easiest if you just do your bill paying and banking in round numbers. For example, you could just attach a colored label saying $100 even if the bill was $101.34 and let the rest carry over till next month. Or overpay it, and get a credit on next month. Or you can use voice recognition software to convert your words of the exact amount to pay, to a transmitted message to the bank.

After paying it would tell you it did it, and give you a closing balance. All this is then printed with the confirmation number on a sheet for you to put back in your file, providing a paper backup, which could be very valuable here. And you can scrawl notes on it for yourself for next months bill paying, bank deposit or whatever.

The page just described is completely dedicated to one purpose, paying the phone bill. After you are through you can write information on the page, or store in a file with the page, a printout of the transaction sent by the bank (or phone company as the case may be). Or you might choose to additionally have the computer store this information, but this opens up the computer for virus attack, which it may be desirable to avoid.

The postbox can be in public places, not just the home or car for example. FIG. 3g illustrates a page 366 used on a trip, in conjunction with a postbox located in an airport, hotel lobby or the like.

In the old days, you would give a letter or a postcard to the desk clerk to mail for you. Or you would mail it yourself by dropping it down a post office box slot on your floor next to the elevator. The postbox of the invention can almost exactly duplicate these historic functions. The Email address however would likely be in a code section 368 on the paper that you wrote the information on, and in the simplest case to imagine, would be a page you brought with you on your trip. For example, your daughter Mary's email address, which person you wish to keep posted on your travels. You can buy a card and stick it on the page too. The page can have sticky substance 367 on it (like a post-it note) for this purpose.

As opposed to having a pre-prepared page, you can attach a name label such as 370 to a page. This could say MARY, but also contain a code 369, which links to the USPS server, which has both sender and receiver information, in this case, a specific recipient Mary. Or it could say ALL, which would be the sender, and multiple pre-stored recipients on the USPS server computer.

In one form, which we feel would be best sold serviced and supported by the Post office itself (USPS in the United states), the postbox would be legally against the law to tamper with.

For the security of the sender and receiving party, the computer of the post box would erase all images taken of the letter 368 after it is sent. For example it would wipe clean the hard drive or other data storage used for the temporary storage of the email and/or person code, address and data. And it might reformat the system too, just to make sure no virus attack can do damage.

In an even more secure version, the USPS for example would maintain a server in which the code on the letter is matched to the sender, and to the recipients email address. Thus someone tampering with a postbox would not be able to know the recipient or the sender, so the data itself would in most cases be meaningless. The USPS would send a bill to the sender (or recipient, in COD fashion) monthly for services provided.

The following applications are ones which would be used most in the home, and don't necessarily depend on communication with remote sources. FIG. 3h illustrates a page used to aid the person in TV watching activities, either using the computer of the invention to actually switch channels and other functions, or using it to send infrared or other remote control signals to a device itself, such as TV, DVD, VCR, etc. Page 374 has on it as shown a list of times and channels and volume settings if desired or if a DVD, the particular track or whatever. The user simply checks off the desired programs and the volume if desired and puts the page in the postbox slot. At that point the computer such as 220 can control the remotes for the device by sending infrared signals at the proper time, for example via the IR port shown. This port could also be radio wave wireless, if near line of sight needed for IR transmission was not possible.

For example, a page can be for controlling the TV. One simply sticks on the words (or in the case shown in the figure, crosses off the words) channel 9, and 9 pm and 10 pm. The computer vision program recognizes the two times, and the channel number and may then easily turn the TV on channel 9 to record it at 9 pm and turn it off at 10 pm. Added information such as volume of play desired could be programmed in as well by similar means, or by ticking off boxes on a sheet, etc.

FIG. 3i illustrates a page 380 used to track weight loss, diet or exercise issues (often all connected). An action page is created for what achieved in a given day, and used. In this case enters it into the computer. A very nice feature is that can make the entries at a gym or restaurant on a simple sheet of paper. Then stick it in the postbox when you get home. In the case shown the entries are for a treadmill with typical parameters for the person listed, with the ones attained that session crossed off or otherwise indicated as discussed above. The data here once read can be stored in computer hard drive 245 for later analysis.

The postbox invention greatly aids many people in filing, storage and retrieval in one's home, or for that matter in a doctor's office, or other place of work, or anywhere. The invention can be used to aid a person to file a paper document used in a way you normally would, and retrieve it in the future. (When you might have forgotten what was, and need a reminder which could be hand written on the page say.) Every body in the family understands it. And you can staple stuff to it easily.

Once again the simplest system is the one where you attach a simple recognizable thing such as a tag saying TAX to a tax form you receive. You put it in your postbox slot, and its picture is taken and filed in a tax file in the postbox computer. You can take it out and put it in a regular file, but at any time in the future if you wish to see your tax records, you just stick in a TAX record REPORT page, and because this function has been preprogrammed in the system , they are all printed out when this page is identified. The page might have a period to check off or identify like one month, 6 months, one year, and so on, so that the printout would be made accordingly. It's noted too that each of the records can have a time stamp attached by the computer, such that when the record, or a listing of records, is printed out it has the information of when the record was stored with it.

As an alternative to attaching something to the form, such as a plastic word TAX for example, which can be recognized as pointed out with pattern matching software, with extra complication one can match a pattern of the users printing or even hand writing, writing the word TAX. One might write it ten different ways such at least one of the 10 would match, such that the computer could properly file the information. And this same procedure can be used for MARY and other email addresses too. The system can do this easily as there is a limited number of addresses or files in any one persons life. Perhaps 5-10 close friends you would routinely write to, another 10 family members, and perhaps 20 files. If there were several people in the household all using the postbox, then the number of possibilities rises, but it still is relatively small and easy to deal with by even the most modest PC computer today.

It should be noted that small children can use it too, with the system able to match their handwriting too. Or they could use symbols for different things or people, like balloons, cakes, toy planes, dolls and so forth. This means that children can email their friends, and perform other functions, even if they can't type or are not allowed to use the main computer of the home.

In addition, the computer of the invention can be used to store reminder information, to tell the person (who may forget, another trait of getting old) what bills or other things need doing. Every Monday on startup it could tell by voice, printout or both what needed to be done, where it was stored and the pages stored to do the actions as well. A friend, a bank person, a caregiver, a child or whoever would likely set up this system.

We note that any of the pages above can be printed on Braille printer, and also with code. A person can write on and send, as can the recipient tell with Braille who it is for. (If the person can't write, he can attach an audio file.) With suitable lighting the camera can read Braille directly. Note too that one can use a Braille identified label to stick on a document as well, so a blind person can send emails just the same!

The invention benefits from use of machine vision teach programs. In set up you just punch in the address, hit teach and the camera associates that label or other tag image on a page determined with that address. With good color recognition, or COGNEX PATMAX or other rotationally invariant template matching programs, it's easy no matter how the label is stuck on or where. Such a teach session is usually done during set up by the helper/caregiver.

The use of specialized pages such as the above has many advantages. One can write paper on lap in easy chair, or wherever. No worries or hassle with hardware. You can take paper input with you to places not conducive for a computer, such as a gym or the beach, and then input the information later.

It is also possible to add further instruction labels such as record voice label 343 shown to the page. When the machine vision program identifies this, in addition to the recipient Mary, it is programmed for example to tell the user to record 20 seconds of recording into the mike of the post box. In many cases the label does not have to be in any particular location on the page. Alternatively one can use a page which has a place on it to be checked off, or colored in or whatever, to signify that a voice record is to be taken and attached to the email in question. One could also add a third label such as a picture icon label, which would tell an optional TV camera to take a picture of the user, and send it too with the email, or perhaps to paste it to the page being sent in a region not used for handwriting or other information, or to paste it as a watermark on the page. The preparation of the transmitted page is made in the computer 220 before the message is sent and all this activity is desirably automatic and transparent to the user, who just can take the paper and walk away if desired.

FIG. 4a illustrates “ballot” types of action pages such as 400, used with a postbox 405 or other embodiment of the invention to select music from a home music system 410. This is a simple way of accessing ones music files, by simply checking off the ones you want. It also is applicable to a party setting where persons can submit their “vote” for particular tunes, much like one would pass paper with names of tunes up to a DJ at a club. This is much more natural than everyone standing around a computer, and can be done while sitting in a living room, on a back porch or other comfortable location. The whole focus is everybody participates by ballot and has fun.

To choose the sequence of tunes, one can use a crude form of character recognition to recognize numbers such as 1-10 placed next to the tune in question. Or one can color code or provide another kind of machine vision recognizable code.

It is also noted the computer of the invention such as 220 and it's hard drive, or a separate hard drive or other medium, can be used to store and cause the tunes to be played, without the use of a separate computer which otherwise might be in the system 410 containing amplifiers, speakers etc.

In this example, a page 400 can have a list such as 401 of all the tunes in the music file, or some subset thereof. For example page 400 can have a code at the top showing that it is a classical music page, where as another page might be dedicated to blues. On the page then the homeowner or his guests indicate their preferences by any of the means discussed relative to FIG. 3 above. For example, crossing out the one of interest, sticking something to it, coloring in a check box, or whatever. Each person's page is then placed in the postbox slot and the tunes recorded (the printout of the page having been created to associate the tunes in the collection with the printed page). If desired, the person can indicate their name, which is also recorded. This can easily be done with pre-taught labels for the players or the like. OCR can be used too, but is more complex. The computer then having read the lists of tunes desired fetches them in sequence from home music storage on a hard drive or other medium. With suitable security precautions they can also be fetched from an internet provider such as NAPSTER.

One can also have a page such as 420 shown in FIG. 4b, on which a sticker 425 in the form of an album cover is stuck to the page by the person desiring that album. This album cover picture is then recognized by the camera of the invention (for example by correlation or template matching), having been taught that label and what it represents in the music file. So for a number of songs you just put lets say 9 album stickers on the page, and the camera recognizes them all and plays the tunes. As before, color and shape as well as a more complex album cover signature can be used. The album sticker is another example of using a code that represents something about the subject like the name “Mary” used as a label in the example above to send email to Mary. Or the word TAX to file a picture of a W-2 record in the tax file in the computer memory.

The list of tunes desired can also be passed around, so that each person checks off his choice on a single sheet for example. Or each person pastes a code representing him or her, on the choice, such that that choice can be associated with him. This code could be his picture, such as a miniature picture which you could paste on or otherwise adhere to the page temporarily.

Clearly programs in the computer need to be generated to accommodate the actions and activity. The important point is that the picking of the tunes is unobtrusive and social, with everyone able to peruse the information at their leisure. And the method of interaction uses real names, album covers, pictures and the like. This is a major advance over standing around a computer looking at words on a screen. This same mode can be used to select TV programs or heating programs or any other functions controlled by a computer in the home or elsewhere as has been disclosed in our previous applications.

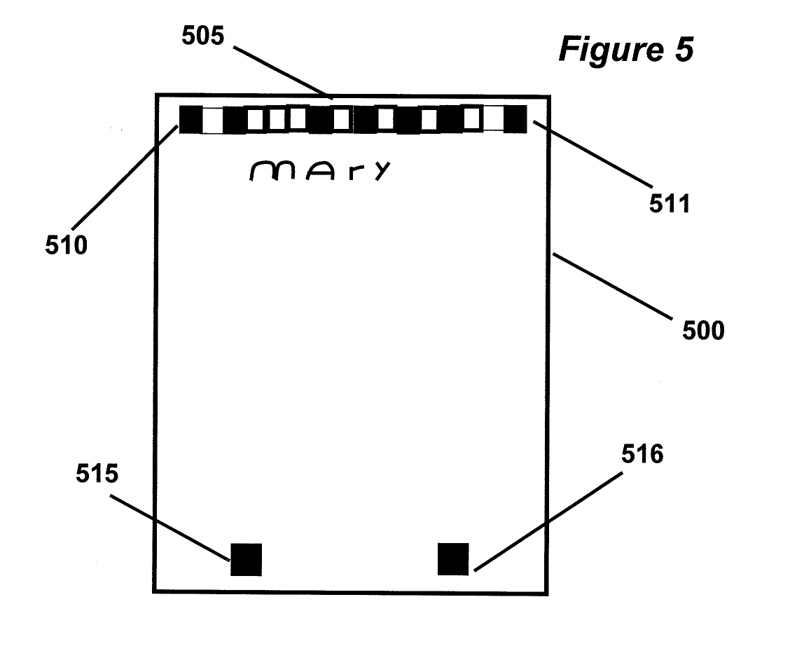

FIG. 5 illustrates pleasing codes of the invention using a variety of colors, shapes and designs.

It should be noted that a color code has to our knowledge not been used on a document before for the purposes herein, and may be made pleasing to the eye, such that unlike previous efforts to hide codes, this one is actually used in part for decoration of a page. It can have different shapes as well and the combination of color and shape, as well as spacing location and other variables creates an unambiguous way to identify persons and addresses.

More detail is now provided with respect to the color code disclosed in figures above. For example, the basic code described above has been a horizontal (or vertical) series of colored bars (rectangular in this case, but not necessarily so). In the case shown in FIG. 5, a page 500 has at the top a row 505 of, in this one example, 16 colored bars, including two black bars 510 and 511 at each end, which are used to reference the locations of the other bars in the camera field, and to align the page and correct the camera perspective of the page, when used in conjunction with two bars 515 and 516 at the bottom of the page. When fully corrected by known computer techniques the page looks rectangular and is aligned to the camera chip axes, and thence to any display or printer used with the system.

The bars between the black bars typically can be red, green, blue, gray and white, and more colors are possible. The code might represent a simple page number in a book, as well as the volume of a book. Or it could represent an email address, which typically could require more combinations.

This code has a lot of flexibility, since the number of colors which can be seen reliably are at least 10, and there are 14 bars used in one case (not including two black bars one on each end), this makes 14 to the 10^{th} power of combinations, since the bar location with respect to the other bars is fixed by the length of code and the bar count. But consider too, that the camera and machine vision program in the computer of the invention can also see the shape of the “bars”. This means that even more permutations are possible, since each “bar” might have 4 possible shapes for example (e.g., trapezoids, squares, triangles and circles). Thus a judicious choice of color and/or shape and/or bar position gives a reliable code, which can also be aesthetically pleasing and decorative. It is also possible to have even more elaborate codes which are colorful designs whether meaningful or not, like balloons, scrolls, hockey sticks and the like. The code can indeed be totally meaningless in its design, such that the viewer cannot possible attempt to decipher it without having many examples to work from, which could be impossible to obtain.

Typically there is also a name of the page written in text, such as text 530 shown. In this case it is the name MARY that would in this case mean that it was a page used to send an email note to daughter Mary. It could also in a different circumstance, mean Mary's bank account, credit card or whatever, so if there was multiple such Mary related pages, they would each be named and coded differently to suit.

At this point we would like to make a summary comparison of the postbox device of FIG. 2, and to a degree the invention in general, to two other devices—faxes and scanners, both of which take an image of a document by physically moving a line array of detectors relative to the document. Neither one in its present form is used for casual email communication or to control devices in one's home such as disclosed in co-pending applications and herein.

The invention is fast. If the goal is to send a single page of information to somebody, or use a single page of information to control something, then the invention herein and particularly the version of FIG. 2 called the “postbox” is significantly faster than a fax or scanner, which use motor driven scans relative to line arrays of detectors. In one motion you can put the page into a postbox, and pull it out. Everything is automatic from information associated with the page itself, no buttons to push, no keys to punch, no lids to open and shut, and no mechanical jams or other alignment or feeding problems. The postbox can send a document to an email addressee in less than a second or two of the user's time. (The time needed to put the document in the device and pull it out.) A fax or scanner takes 5-10 seconds or more. And much more if the paper jams in the fax. And with the postbox, there is no starting up a computer etc. to use it at all (the case of all scanners today). For a senior citizen, a disabled person, or someone just plain in a hurry, this is a big advantage. If multiple pages are needed, the postbox however is less convenient than an automatic feed fax, but still more convenient than a scanner. Many of the uses contemplated however require only one page.

The invention accepts different paper sizes. This is particularly a problem with fax machines, which can jam or become difficult to work if anything but standard paper sizes are used. The postbox can accept anything in width up to its slot width, and any size postbox can be built by simply varying camera focal lengths (and box size, unless mirrors are used to fold the beam path). A single postbox can be used to send a recipe on a 3×5 recipe card to a friend, a doctor's prescription to a pharmacy, and a 8½×11 letter to someone else, and to take a photograph of a photo and send it too, maybe on the same page.

The invention accepts different page thicknesses and materials and accepts “3D” pages (i.e. those which are bent crumpled, with things sticking up, etc.). This is impossible for faxes, and not easy if not impossible for scanners due to their limited depth of field (requiring the cover to force the page against the platen, because other wise the thing sticking up pushes the paper away from the platen causing fuzziness due to out of focus condition). In addition both the scanner and the fax have platens against which a document is pushed. If the document is sticky (see FIG. 3 for an example) this is impossible for continued use (and at all in the fax). The invention uses no platen, and for information such as the documents and emails and such normally used, can tolerate a depth of field of at least 0.2 inches and in some cases 0.5 or even 1 inch. This makes it easy to drop a page into the slot and take its picture so to speak, without any concern for position, saving time and potential jams.

The end result is that the postbox invention disclosed herein can utilize novel methods for conveying information not possible with the other devices, even if people could know how to use them. And it is easier to load, as there can be “slop” in the direction perpendicular to the plane of the paper. The price for this, is less resolution of fine detail over a large area, but the postbox with reasonable camera pixel counts (640×480 and above is recommended) is more than adequate for many applications of interest to the community it serves. A depth of field and “slop tolerance” of at least half an inch is desirable and easily achieved with the invention. The good depth of field can allow one to reliably read information from and transmit information on pages at varying distances which are dropped in slots, sticking out of fridges, loose on clipboard, etc. Also, camera distance on clipboard variable, so the camera can self calibrate.

The Invention is easy to use. This employs some of the advantages referred to above. Consider this: that in one version all you have to do to send an email of a letter or any other page you wish, is to stick or stamp on the page a recognizable name or other object representing the person, and then drop the page in your postbox. That's it, you can take the page out instantaneously and file it away or do something else with it.

The invention sends all pictures in color. This is uncommon for fax machines, at least those that are reasonably priced.

The invention is also low in cost. We believe that in similar quantities that the postbox will be less expensive than either alternative, due to the lack of moving parts and other factors. This is especially true since neither fax nor scanners to day are set up for transmission to email, without considerable added equipment or cost. And neither is well suited for the control applications of the invention.

Robust and Reliable—the computer system is meant for relatively low volumes and can have numerous robustness features built in that a more flexible and more used computer based device would choke on.

Appearance—the postbox need have little or no protrusions, or technical looking pieces, and in this form it can be a piece of furniture one can leave in one's living room with pride.

The invention has voice communication capability. While this can be added to computers associated with scanners, or faxes, this too is not known to be in a self-contained unit along with the imaging device, as in our postbox.

With the invention, multiple functions may be actuated with single page. This is unknown in scanner and fax applications that we are aware of. For example: go to internet and inquire about room rates at 4 motels ticked off on a sheet; go to bank, get balance in two accounts, and pay bill (could also have pay bill formula, like from account with most money in it); print out results of having fetched, and so forth.

The invention we feel is the fastest and easiest way to economically transmit a limited amount of handwritten information, or a photo or some piece of printed material such as a recipe card. And like email in general, to multiple addressees if desired. In addition, it is easy to put paper in it, a big boon for anybody who is in a hurry and doesn't want to deal with a jam. It also sends the data in one motion, without punching buttons or the like. The postbox is free of frustration, which also assists speed. It doesn't crash, nor does the information become caught up in other computer tasks or complex operating systems.

The invention may also be used in a vehicle, for example to aid a passenger in the vehicle to work the entertainment system, the navigation system, or to use telematic facilities in the present or future. The invention is particularly useful in this context for use when one is not driving, and particularly thus serves the passengers in the vehicle. In this context there is no known prior art, other than controls such as knobs and switches, which are in reach of the passenger, which are typically very few in the rear seats. While it possible to provide a classical remote control type unit communicating with the vehicle by wireless means for example, such a device can be easily lost or broken or have pop spilled on it. And in any case such remotes are historically not easy to work for complex tasks, especially by occasional passengers in the vehicle.

We note that the passenger(s) is often the one using navigation and entertainment and is always the one using video entertainment. Passengers would also be the ones most likely explore motels and other telematic transmitted information (except maybe traffic reports, but even that is likely to some degree).

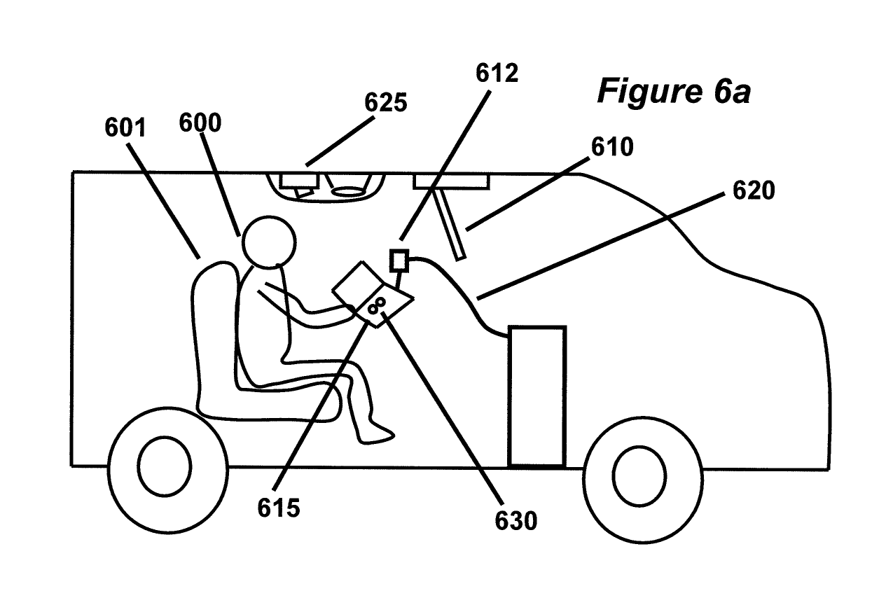

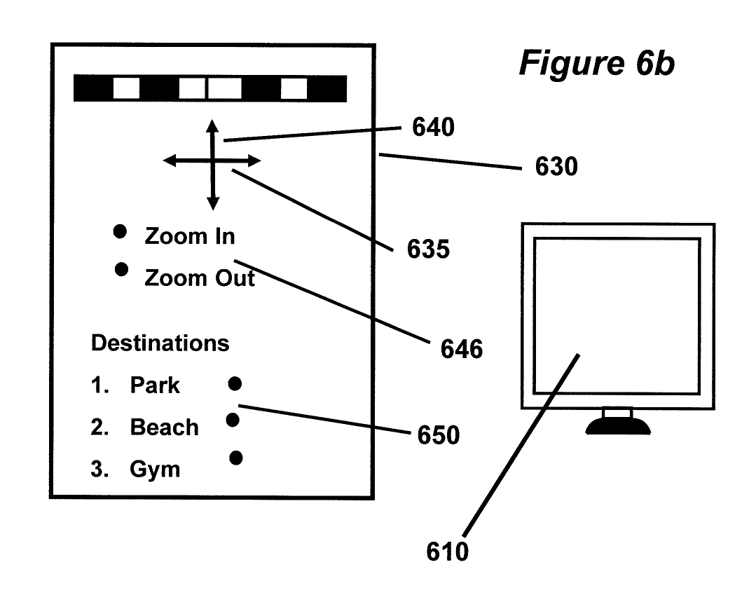

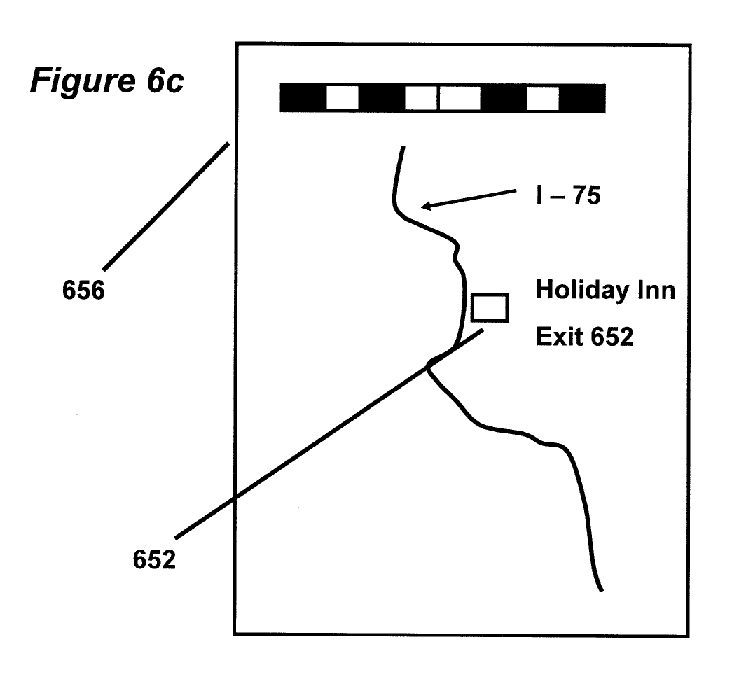

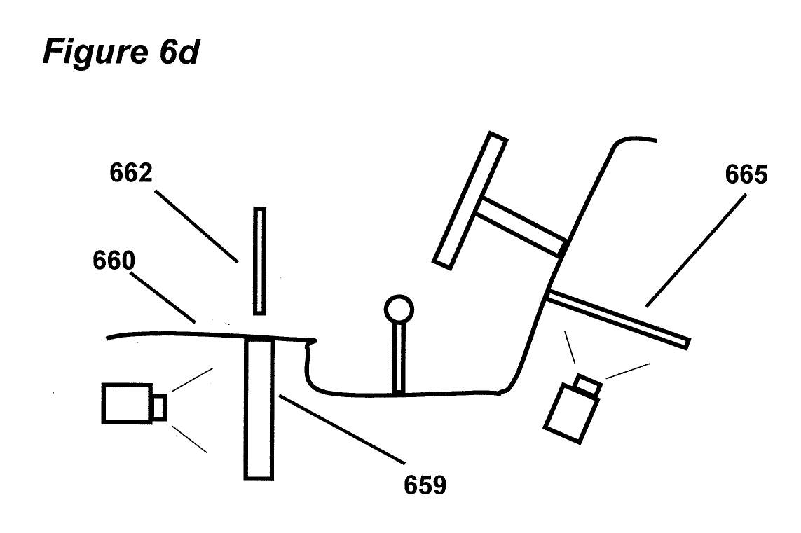

FIG. 6a illustrates an embodiment of the invention usable by persons in a vehicle, in this case in a person 600 in the rear seat 601 for telematics, entertainment, navigation and other activities. The person is typically belted in to the seat and cannot easily reach controls typically mounted overhead for use with LCD screen 610. Using the invention however, this becomes easy and fun.

For example, one can use the clipboard mounted camera version of FIG. 1, with the camera 612 viewing a page located on clipboard or other member 615 and tie the camera cable into a cable connector such as connector 620 for video data in the side pillar or armrest of the car. Since it is only paper or a plasticized page for example that is being interacted with, there is no need to worry about spilling anything on the control or breaking something etc. Alternatively, to have no hardware at all in harms way, one can have a camera such as 625 built into the pillar or headliner to image a page such as 615 held on the persons lap, or other platform.

In this example, one can use the same type of control for DVD, TV etc discussed above in FIG. 1-3, and one can also have telematic pages for selection of motels, places to go etc. And one can just have map navigation functions provided to the rear seat passenger like those provided to the driver on the dashboard today. This gives the rear seat passengers the ability to do everything the front seat people can do, also with a bigger screen than is currently possible to install in the center stack of vehicle instrument panels. This is a major advantage. This holds true for all other functions on the instrument panel too, like the audio system.

For example consider map controls on page 630 of FIG. 6b, in which the passenger may assist the driver in navigating on a family trip. Navigation controls on the page are action swipe (see FIG. 1 for explanation) locations up-down 640 and left-right 635 which are used to scroll the map displayed on the screen 610 or an instrument panel mounted screen. Zoom controls 646 may be on the page which are activated by touching and leaving the finger there for a period of time as (also discussed in FIG. 1).

To make it easy to check on how to get to a place from where you are, a series of places 650 have been pre-programmed before the trip or trip segment in question. These are selected by touching the destination, which allows the navigation system to compute and display the best route. This may seem cumbersome but it avoids requiring a keyboard. Voice input might be usable here instead.

FIG. 6c illustrates a telematic application TRIPTYCH style (AAA and CAE use this) page 656 in which various things along the route are noted, and may be touched by a passenger (or the driver if so equipped) if of interest in order to create an action. For example, when this is done, information from that location, for example the motel corresponding to the name and picture 652, is downloaded to the vehicle (and/or called up from onboard data storage on the vehicle). This is a quick and easy way to find info on motels places of interest and the like while en route.

Controls for the DVD player, or a television receiver, linked to screen 610 can be provided as discussed in FIGS. 2-4 above. Similarly satellite radio selections may be controlled as well, presenting the various categories and play lists on pages from which selection can be made. These can be downloaded to the car thru a server run by the satellite radio company for example, and used by the car owner to print pages off before leaving (either with a printer in the vehicle, or a WIFI connection to a printer in the home, the more likely case).

To illuminate the page typically on the lap of a person, or on a tray table or something similar, there is a requirement at night for light that is typically provided by map lights and other lighting devices in the car. These can be replaced or supplemented by for example LED lights (on the clipboard or for example in the headliner area). IR LEDs can be used if needed to further illuminate the page for the camera to see without the passengers being able to see the brighter illumination which could distract the driver.

The clipboard used to hold the page, or a book of pages, can if desired be outlined on for example its edges, or with special targets at its corners, with high contrast material such that it can be found easily in a larger camera field of view. This can be retro reflective even if suitable LED or other lighting is provided near the camera axis.

It can be appreciated that the page of controls 630 can also be used to play games, and that screens can be located for example in both the second and third seats of a minivan so that passengers can play against each other. Similarly cameras can be positioned to view all rear seats of a minivan or other vehicle in order that passengers can interact with the screen, and either use the systems as described or play games with each other. The right front seat passenger can be included too, if a screen is available for their use. Several such screens have been proposed on instrument panels, including ones that rotate toward the passenger.

There is also the possible application of a postbox like FIG. 2 in the car. For example built right into the instrument panel, center console, or other location. The information to be sent is transmitted via cellular sources, ONSTAR, or Wifi for example, when the car is near a receiver location. If ONSTAR was the server, they could control all, like the USPS example above say.

For example consider FIG. 6d, which shows a slot 659 in the car center console 660 in which one places a letter 662, whose picture is taken by the camera of the invention in a manner similar to that of FIG. 2. This slot could be more horizontal (and free of spilled coke) if located like slot 665 in the center stack of the instrument panel. But the postbox operation allows vertical positioning since the camera axis is horizontal and all key components are out of harms way, and any spill can be drained out the bottom.

This car-mounted postbox allows one to send quick emails or perform other functions in the vehicle by dropping ones letters or other information pages into the postbox slot. This is particularly valuable as a method of communication as it is hard to type in a moving car, and voice is sometimes drowned out. One can also drop documents in for use in a storage and retrieval mode such as toll or gas receipts and the like which can be stored in the postbox or another computer as JPEG images for example. This is handy for a salesman or other person on the road a lot.

It should be noted that one could also select music from MP3 files stored on a hard drive or other medium in the car, using the invention. In this context it is useful to have a book of music choices, with let us say each page representing something, like classical, or even a subset, like Bach. Then on the page is listed 20 choices, which can be swiped or otherwise identified to the camera in the car. When one turns to a new page, that page code is read, and those choices at those positions on the page are identified as relating to certain selections stored on the hard drive. It is the inventors belief that as the number of such possible selections rises, the need for the invention becomes ever more useful, as it is fast, easily organized into a traditional book form, or by individual pages which can be easily seen, interacted with and arranged.

Like the party application mentioned in FIG. 4 above, this also allows the book to be passed around to multiple persons in the car for them to make their input. And in another example, each can have their own book of selections and if a camera is located to view their book on their lap, then each can input their selection choice. This holds for video as well. And other pages in the book can represent other functions too, like navigation and the like.

It should be noted that the page could be metallic with magnetic devices stuck to it for ease of identification by the camera. And it can be plastic or metallic such that levers and knobs may be operated on it for other functions. A “holster” can be advantageously provided in the vehicle interior to hold a clipboard or other platform used by the invention.

For a hundred years or more, the secure mode of communication has been registered mail. Secret documents, share certificates and money are sent this way (as well as by the time honored use of couriers). It is also trusted and familiar to the older user who is the primary potential postbox user we feel.

The invention can make use of this mode in which action pages are sent to the user by Registered mail. The page can have the originators code (e.g. a color bar code as described herein, or another suitable code) on it, for example a banks address code. The communication then going back to the originator can be by secure internet handshake protocol between the sending postbox or other invention device controlled at the user end by the action page.

A message from the user to this address could even include an instant shot of the persons signature superposed on the page, or a video clip of the person saying to pay the bill and how much. The military might find this useful as well, especially since the postbox can very simply be used to send handwritten messages. There is a saying not to give verbal orders, and this allows quick written ones, with a degree of security—in fact ultra secure in some aspects at least, if the handwriting is recognizable as the senders, by the recipient. Or it could have a recent overlaid video image of the sender on it, which would be recognizable. Such handwriting could include drawings such as battle maps for a platoon say. The handwritten information remains in the form it was written, which means it can be authenticated at the remote site to which is transmitted.

Doctor's prescriptions can be sent this way in their basic handwritten form to a pharmacy as well. As noted above the machine vision software of a postbox or other device of the invention can be taught to recognize a limited set of hand written words of a certain person. These words can be an address label such as MARY written by the person who wishes to send something to Mary. Or it can be the signature of the sender, or both. This imparts a degree of security, since the machine will only send a given addressee a message, if the signature of the addressee is recognizable as coming from the sender. Even if one found one or the other signature, you would have to have both to send the message.

The signature of the sender can also be used to authenticate a transmission to a degree. It can be imaged along with the note, or other information sent, and sent on the image of the page with it.

Robustness is another aspect of security as well as function of the invention. The postbox can be used with appropriate connection of the computer to outside servers through DSL modem 41 and the like to interact via email with the outside world so to speak. To assure robust operation in this manner, it is desirable that the device remain connected to the internet only as needed, and if necessary that the system be automatically reformatted after each session, or daily or whatever other time is desired, such that no virus can take root. In addition, it has to function to defeat hackers and keep viruses out while still reliably connecting with internet. One reason is that for most postbox users, it is not used often; and thus the users would not have time to reformat even after every action with the outside world via the net. In addition, the page of the invention itself has necessary info, not the computer. So there is nothing critical, which can be stolen by hackers, even if they can get in.

The embodiment of FIG. 1 particularly can be used as a mouse to draw on paper at the same time you draw on the screen of a computer display. And you can draw on photographs or blue prints or other things than just sheets of paper too. This is advantage that the ANOTO pen does not have since it must use special paper sheets. And the invention is absolute in its determination of location, not incremental like a mouse.

The invention is a hybrid in some cases, allowing you to learn from a page or more typically from a book of pages, as disclosed in co pending applications, while also allowing you to access the computer or internet directly from the page.

It should be noted that an action page can be downloaded to the printer of the invention and used to set up the system of the invention itself. This is achieved by using encoded data within the page such as XEROX DATAGLYPHS, or the system described by COBBLESTONE software on their website. Use of the page to do this, means one does not need to transfer computer files over the internet in classical form, and the page information can be encrypted as well, if the postbox or other workstation of the invention has the code to unravel it.

It should be noted that the camera can be mounted sideways and the image rotated 90 degrees in the computer if necessary. This is useful for example when mounted in a sidewall such as that of the car, or next to a kitchen counter etc. It should also be noted in the examples of FIG. 3 that the addressee word MARY could be in white (light) letters on a black (dark) background member attached to a white page with say handwriting on it. The computer can find the member and determine the signature of information within it (of view the whole member as a signature which could be taught for example). And there can be a code associated with the word Mary, either a color code, or something else like a bar code say. So you wouldn't have to read Mary per se with the camera, but rather the code.

Note that the word, for example COMERICA BANK, on a card or by itself for attachment to a page, is like a credit card, sent registered mail for example. You just store a bunch of these cards in a safe place for example. And use them for transmission of data. The information to relate the word to the proper action can either be sent with the card, or contained within the card.

One can use a page made from a steel sheet and the word MARY can be a magnet which you can place anywhere on the sheet. And you use it or another magnet to hold your handwritten letter or photo or whatever you wish to send or store, to the sheet. You then place it in the postbox, and off it goes. Then you put your MARY magnet back. Such a thing works vertical or horizontal or any other orientation. But maybe it leads to horizontal, where you would slide the sheet in like a cookie dough tray and then just pull it back out with the same motion. You can also have buried round magnet positions in the sheet, which cause attraction of other metallic pieces to specific points on the sheet (for example a steel name tag MARY).

It should be noted that the postbox and perhaps other invention embodiments allows very young children to send information to their friends at no cost.

The postbox can also be used in a hospital setting, as a convenient method to take paper documents such as prescriptions, charts, test results and the like, and transmit their image to a server for dissemination to medical staff. These documents may not have originated in the hospital and thus are not on the hospital computer system, or they may be hand written notes of importance or the like. Or they could be photos of patients or portions thereof, taken quickly by a nurse on her rounds, for example. And it can be used for something more mundane like a rolling cart used to take menu orders for the day from patients, and transmit them to the hospital kitchen by intranet, or the internet.

A convenient solution to nursing documentation system can be implemented as follows. Nurses often have to record what tasks they have performed on a given patient in order that their facility gets reimbursed by government and insurance. Electronic computing devices are heavy, inconvenient, and can fall in the toilet. Further, they are difficult to clean and can accumulate germs as the nurse passes from one sick patient to the next. Instead our system allows the nurse to carry a small ring notebook in her pocket that can be filled before each shift with pages specifically designed for her patients and printed off before she starts her shift. She would simply turn to the page for the current patient and then color a box with a colored marker over each item that she performed or each condition that she saw in the patient. After performing her rounds, she would take the pages out of the notebook and drop them one at a time into a postbox described herein. This system has the advantage that it is cheap to replace if it gets soiled. Thus, it is not a germ carrier. This invention in every form allows for an inexpensive, disposable, and replicable paper based interface that provides a clean interface to a computer that can be used in many dirty, germy environments. It would be unwise to use traditional computer interface equipment such as a keyboard, mouse, or touchscreen since these could collect the germs of a patient, or the contamination of nurse attending a wound, or contamination from a chef in a kitchen working on a chicken. Anyone doing a dirty or greasy task that needs computer help or documentation support would benefit from this invention.

While the invention has been described in connection with numerous embodiments, it is to be understood that the specific mechanisms and techniques which have been described are merely illustrative of the principles of the invention, numerous modifications may be made to the methods and apparatus described without departing from the spirit and scope of the invention.

What is claimed:

1. Apparatus for entering data into a computer, comprising:
a base item providing general identify information;
an object with additional information, which object is removably attached to said base item by a user;
a housing, having an opening for insertion by the user of said base item with the additional information thereon;
a TV camera within said housing for imaging the general identify information provided by said base item and also for imaging the additional information of the removable object, when said base item is placed into said opening in said housing;
a storage means for storing a database concerning at least a portion of the general identify information of said base item and the additional information of said object;
a comparing means for comparing the identity information imaged by said TV camera of said base item with identity information of said base item in said database to determine an identity of said base item, and
entry means to enter data into a computer, based on the identify information of said comparison, corresponding to at least a portion of the additional information of said object.

2. Apparatus according to claim 1, wherein said TV camera is a color camera and said comparing means uses color information of the base item and of the database.

3. Apparatus according to claim 1, wherein said camera is part of a cell phone.

4. Apparatus according to claim 1, wherein said opening is a slot into which a user inserts said base item.

5. Apparatus according to claim 4, wherein said housing has a bottom which said base item falls out of after insertion by the user.

6. Apparatus according to claim 1, wherein said data is an image of at least a portion of said object.

7. Apparatus according to claim 1, wherein said identity information is contained within a code on said base item.

8. Apparatus according to claim 1, wherein said identity information is the name of a person to whom said data is to be sent.

9. Apparatus according to claim 1, wherein said identity information is an action to be taken by said computer.

10. Apparatus according to claim 1, wherein said identity information is the name of a file in which said data is to be stored or subsequently retrieved.

11. Apparatus according to claim 1, wherein said stored database contains a pattern of information corresponding to expected text, handwriting or graphic information provided on said base item.

12. Apparatus according to claim 9, wherein said action controls a device selected from a group consisting of a TV set, a cable or satellite receiver, a stereo system, a video data recorder or player, a furnace, a kitchen appliance or a communication device.

13. A method for directing image data taken from a page comprising the steps of:
providing a base page having printed, handwritten, or graphical data provided thereon including general identify information;
removably attaching an object with additional information to said base page;
providing a computer;
storing a data base concerning information on at least a portion of said base page in said computer, including the identity information of the base page;
imaging at least a portion of said base page with a TV camera having an output, the portion including the identity information of the base page and also the additional information of the removable object;
storing in said computer an image obtained by said TV camera of at least the portion of said base page and the identity information of the removable object;
analyzing, using said computer, said TV camera output to provide information concerning said base page and the identity information thereof; and,
using said information, directing a disposition by said computer of said stored image.

14. A method according to claim 13, wherein said identity information is an email address and said disposition includes the sending of an email containing said stored image to said address.

15. A method according to claim 13, where said identity information is a file address and said disposition includes the filing of said stored image in a memory location of said computer.

16. A method for facilitating computer based activity by senior citizens and other users comprising the steps of:
creating a base page of information including identity information and further including an object which is removably attached to said base page and which includes additional information;
providing a TV camera contained within a housing into which the base page of information including the object is placed by the user;
providing a computer to store and analyze at least a portion of said TV camera image, the portion including the identity information of the base page and additional information of the removable object;
placing said base page into said housing;
obtaining an image of said base page with said TV camera including the identity information and the additional information of the removable object;
analyzing at least a portion said image with said computer to determine a computer based action desired by said user and the identity information of the base page; and
using said determination and the identity information, performing the computer based action desired.

17. A method according to claim 16, wherein said action is a communication activity of emailing of information to another person.

18. A method according to claim 16, wherein said action is a storage and retrieval activity of a document image or portion thereof in a computer file.

19. A method according to claim 16, wherein said action is an entertainment activity of a selection of TV or music programming.

20. A method according to claim 16, wherein said action is a health related activity.
